(19) United States
(12) Patent Application Publication
(10) Pub. No.: US 2003/0177075 A1
(43) Pub. Date: Sep. 18, 2003

(54) Installing advertising material in the form of a desktop HTML page and/or a screen saver

(76) Inventor: Paul E. Burke, Riverdale, NY (US)

Correspondence Address: Mr. Walter J. Tencza Jr., Suite 3, 10 Station Place, Metuchen, NJ, 08840, US

(21) Appl. No.: 10/100,473

(22) Filed: Mar. 18, 2002

(51) Int. Cl. G06F 17/60

(52) U.S. Cl. 705/27

(57) ABSTRACT

A method is disclosed comprising the steps of causing an desktop HTML page to be placed on a visitor display and an desktop HTML page computer software program to be placed on a visitor processor in response to an install desktop HTML page process. The process may be started by the selection of a first link on a vendor's web site page by a visitor to the vendor's web site page. The desktop HTML page is placed on the visitor display as a desktop menu or display. A method is also disclosed comprising the steps of causing a screen saver to be placed on a visitor display and screen saver computer software to be placed on a visitor processor in response to an install screen saver process. The install screen saver process may be started by the selection of a first link on a vendor's web site page by a visitor to the vendor's web site page. The desktop HTML page or the screen saver may each contain advertising material for the vendor.

### FIELD OF THE INVENTION

This invention relates to improved methods and apparatus for accessing and driving traffic to web sites.

### BACKGROUND OF THE INVENTION

Typically in the prior art a user or visitor accesses a web site address by activating a web site browser such as “Internet Explorer” (TRADEMARKED) or “Netscape” (TRADEMARKED) and then entering a web site address on an address line. This is inconvenient in that it requires several steps and requires the user to remember what often may be a difficult to remember, or difficult to spell, web site address.

It is known to place an icon onto a desktop or Start Menu for the purpose of accessing desktop applications such as Microsoft Word (TRADEMARKED) and Quicken (TRADEMARKED). These icons link to executable programs for the desktop applications. A desktop, or desktop menu or display, is typically the screen that automatically is displayed on a visitor or user computer monitor or display each time the user's computer boots up and any time a user does not have a particular application computer program displayed.

Desktop computer software applications are known in the prior art for installing what is typically called “wallpaper” on the user's desktop. “Wallpaper” is used for aesthetic purposes and does not include any HTML (hypertext markup computer software language) or interactive elements. “Wallpaper” is “static” and cannot be dynamically updated by the vendor.

“Wallpaper” typically is comprised of a manually executable computer program, which is large in file size. Because of the large file size typically a slow download is required when downloading “wallpaper” from the internet for example. The installer computer program for “wallpaper” typically must be saved to the hard drive of a user. An executable computer program for “wallpaper” typically must be located on the hard drive of a user. This computer program must then be manually “run”. “Wallpaper” is distributed by the vendor typically for aesthetic purposes. “Wallpaper” is installed by the client or user, typically for aesthetic purposes. “Wallpaper” is a single bitmap image file. The executable programs for installing “wallpaper” are slow, manual, confusing, and not very “user friendly”. These executable programs “run” visible to the user.

Active desktop items are known in the art. An active desktop item is an “object” that requires the Windows (trademarked) desktop operating system to display it. An active desktop item typically does not occupy the full desktop display area or screen. An active desktop item is typically a floating item that can be resized and moved around the screen.

Active Desktop items are configured using a proprietary .CDF file that requires knowledge of a specific scripting language. These .CDF files typically do not contain a separate diagnostic tool to identify problems. Active Desktop items typically require a user to accept two security prompts before downloading and installing the active desktop item. Active desktop items installer computer programs do nothing if the user clicks “Cancel” on the first install prompt (and this cannot be configured by the vendor). Download status and progress for active desktop items are displayed in a separate box initiated by the Windows (trademarked) operating system.

An active desktop item is an individual element that typically “sits on” the desktop display and is separate from the desktop display. Active desktop item technology allows multiple items to co-exist on the desktop display. A user must choose the option “make available offline” or an active desktop item content is not stored on the user's hard drive and is not available when there is no Internet connection. For an active desktop item the decision to enable or disable “webcasting”, (dynamic updates) is made by the user. Information on dynamic updates is typically not recorded in a log file. After installation of an active desktop item occurs, the user typically cannot view a diagnostic output of installation. Typically the download process for an active desktop item does not include a help link. An active desktop item typically cannot automatically prompt a user to install the active desktop item when the user visits an internet web page. An active desktop Item is typically the second to lowest layer of the desktop display.

Active channels are known in the art. For active channels a channel bar on a desktop display, shows logos for each subscribed active channel.

Typically to install a prior art wallpaper or a prior art screen saver an executable file was required. This means that a user would have to manually download a file, save it, find it on the user's computer hard drive or processor, execute it, and then run through an installation process.

### SUMMARY OF THE INVENTION

The present invention allows the download and installation of a desktop HTML page or screen saver to happen right from a web page. The desktop HTML page is referred to at times as “HTML Paper”, although the term “HTML Paper” was not known prior to the present invention. The screen saver will be referred to simply as screen saver.

In accordance with the present invention, the desktop HTML page or screen saver is typically internet or web enabled computer software which is relatively tiny in file size compared, for example, to prior art “wallpaper”, or to a prior art “screen saver”, respectively. The desktop HTML page or screen saver of embodiments of the present invention download quickly from the internet and the installer computer program for the desktop HTML page or screen saver typically does not have to be saved to a user or visitor's computer hard drive or processor. The desktop HTML page or screen saver computer program works directly from an internet web page and “runs” automatically. The desktop HTML page or screen saver may be distributed by the vendor typically for marketing purposes. Desktop HTML page computer software or screen saver computer software in accordance with the present invention may be installed by the client, user, or visitor, typically to gain value such as additional information, services, convenience, or special offers. The computer software for providing a desktop HTML page in accordance with embodiments of the present invention may be an HTML computer software program file that can include many dependent files for images, sound, and more. The computer software that is a desktop HTML page in accordance with embodiments of the present invention may contain full HTML and many interactive elements.

The computer software for automatically downloading and installing desktop HTML pages from a web page may include a unique updateable desktop HTML page technology which allows a vendor to automatically update a client, user, or visitor's desktop HTML page at any time. The computer software for automatically downloading and installing screen savers from a web page may include a unique updateable screen saver technology which allows a vendor to automatically update a client, user, or visitors screen saver at any time.

Installing a desktop HTML page or screen saver in accordance with the present invention is quick, simple and “user friendly”. The desktop HTML page or screen saver computer software runs “invisibly” to a user (actual computer software application runs in the background on the user or visitor's processor after the user gives permission to install the computer software for the visitor's desktop HTML page or screen saver. After installation, in addition to the desktop HTML page or screen saver being installed and active, typically the updateable desktop HTML page or screen saver is installed and actively looking for updates as well.

The desktop HTML page computer software (also called “See You Again HTML Paper™) or the screen saver computer software (also called “See You Again Screen Saver™”) of the present invention is typically configured using a standard HTML file that does not require knowledge of a specific scripting language. The HTML computer software for the desktop HTML page and the screen saver computer software for the screen saver typically is shipped to a vendor with a convenient diagnostic tool to identify any problems with the set up. Desktop HTML page computer software and screen saver computer software in accordance with embodiments of the present invention typically requires the visitor or user to accept a single security prompt before downloading and installing. Desktop HTML page computer software and screen saver software notifies the user they should not click cancel and gives them a second chance to restart the installation process (this can be fully configured by the vendor). Download status of the desktop HTML page and screen saver computer software program of the present invention and progress can be displayed directly in the existing web page on the visitor's processor. Desktop HTML page computer software in accordance with the present invention, is an HTML page that does not specifically require the Windows (trademarked) desktop to display it (e.g. can be displayed in a web browser). The display produced by the desktop HTML page computer software typically occupies the full desktop area on a visitor's screen. The desktop HTML page provided by the present invention is typically a fixed item that cannot be resized or moved around the screen.

A desktop HTML page in accordance with the present invention “snaps” to the desktop, effectively becoming the desktop display. Desktop HTML page technology in accordance with the present invention allows a single desktop portal to become the desktop. The content of a desktop HTML page in accordance with the present invention is typically always stored on the user or visitor's hard drive and is available whether or not there is an internet connection.

“Updateable desktop HTML page and updateable screen saver” (dynamic updates) can be an integral part of the desktop HTML page computer software or the screen saver computer software in accordance with the present invention. The decision to enable or disable updateable desktop HTML page and updateable screen saver is made by the vendor of the desktop HTML page computer software or screen saver computer software.

Information on dynamic updates is recorded to a log file. After installation occurs, a user can view diagnostic output of the installation in a Java console. The process of downloading desktop HTML page computer software or screen saver computer software in accordance with the present invention to a user's computer typically includes a help link. Desktop HTML page computer software or screen saver computer software in accordance with the present invention can automatically prompt a user to install when the user visits a web page. The display provided by the desktop HTML page computer software in accordance with the present invention is typically the lowest layer of the desktop display.

The image produced by the desktop HTML page computer software of the present invention is typically not displayed as a logo on a bar containing multiple channels. Rather, it is typically a single desktop portal that occupies the entire space of the desktop.

In one embodiment of the present invention a method is disclosed comprising the steps of causing an html (“hypertext markup language” computer programming language) paper to be placed on a visitor display and an desktop HTML page computer software program to be placed on a visitor processor in response to an install desktop HTML page process started by the selection of a first link on a vendor's web site page by a visitor to the vendor's web site page. The desktop HTML page is placed on the visitor display and the desktop HTML page computer software is placed on the visitor processor, so that the desktop HTML page is displayed when the visitor processor is booted up and when no other application computer software programs are active on the visitor display.

The desktop HTML page placed on the visitor display may include advertising material for the vendor. The desktop HTML page placed on the visitor display, may cause the vendor's web site or another web site to be accessed when the visitor clicks on one or more linked elements in the desktop HTML page. The desktop HTML page also may include a broadcast window, which provides updated information from the internet. The updated information is typically not limited to the broadcast window. For example, the vendor can choose to send an update that changes the entire look and feel of the Desktop HTML page image on the visitor display itself and its contents.

The present invention may also include a method comprising the steps of causing a screen saver to be placed on a visitor display and screen saver computer software to be placed on a visitor processor in response to an install screen saver process. The install screen saver process may be started by the selection of a first link on a vendor's web site page by a visitor to the vendor's web site page. The screen saver may be placed on the visitor display and the screen saver computer software may be placed on the visitor processor, so that the screen saver is displayed when the visitor processor is booted up and when a visitor interactive device has not been used for some period of time. The screen saver placed on the visitor display may include advertising material for the vendor.

The screen saver placed on the visitor's computer may include advertising material for the vendor. The screen saver may cause the vendor's web site or another web site to be accessed when the visitor clicks on one or more linked elements in the screen saver. The vendor can choose to send an update that changes the entire look and feel of the screen saver on the visitors computer.

The desktop HTML page computer software of the present invention may include updateable desktop HTML page which may be the computer software which runs on the visitor's computer and looks for an updated version for the desktop HTML page image every so often, which may be every fifteen minutes. The screen saver computer software of the present invention may include updateable screen saver which may be the computer software which runs on the visitor's computer and looks for an updated version for the screen saver every so often, which may be every fifteen minutes.

If an update is available, the visitor's processor downloads the new files and automatically updates the desktop portal, i.e. the desktop HTML page image produced on the visitor's screen or monitor. If the screen saver process was previously initiated, and if an update is available, the visitor's processor also downloads the new files and automatically updates the screen saver.

The present invention in one or more embodiments provides a method and apparatus for distributing and updating advertising or informational material and accessing a web site. Part of the computer software for implementing the present invention will be called “See You Again HTML Paper™” software in this application. The other part of the computer software for implementing the present invention will be called “See You Again Screen Saver™” software in this application. This software can be purchased by a vendor having a vendor web site. The vendor can run the “See You Again HTML Paper™” or “See You Again Screen Saver™” software on a vendor processor, edit parameters, upload the “See You Again HTML Paper™” or “See You Again Screen Saver™” software to a vendor web site server processor, and activate the “See You Again HTML Paper™” or “See You Again Screen Saver™” software on the vendor web site server processor.

The “See You Again HTML Paper™” software gives visitors to the vendor's web site, the ability to install a desktop portal on the visitor's display to access the vendor's web site. The desktop portal can contain such marketing elements as the vendor's branding, information about the vendor's products and services, company news, special offers, and more. The desktop portal may contain HTML, images, and other dependent files and may appear on the visitor's display.

The desktop portal that appears on the visitor's Desktop display may be placed on the visitor's display as an HTML file. The “Windows” (TRADEMARKED) operating system running on the visitor processor will automatically display the HTML file on the desktop.

A graphic button (e.g. “Download See You Again HTML Paper™!”) or any kind of link is typically included on a vendor's web page at which point the visitor could click on it to initiate the See You Again HTML Paper™ installation process.

The present invention in one embodiment includes a method comprising the step of placing a first link on a vendor's web site page of a vendor's web site. The first link can be a graphic button. The method may also include causing a second link which can also be called the See You Again HTML Paper™ link to be placed on a visitor display in response to a “Download Desktop See You Again HTML Paper™” process started by the selection of the first link on the vendor's web site page by a visitor to the vendor's web site page. The selection of the second link or any of the links contained within the See You Again HTML Paper™ on the visitor display, such as with a computer mouse, may cause a vendor's web site page of the vendor's web site to be displayed on the visitor display.

The selection of the linked elements contained in the See You Again HTML Paper™ (or image) on the visitor display may cause a coupon code, a username and a password, or affiliate identification data to be transferred to a vendor web site server processor, or, in certain cases such as affiliate identification data, the data may be transferred to a separate web site server processor. The See You Again HTML Paper™ installation process may include granting privileges to allow the “See You Again HTML Paper™” software program to make changes to computer software running on the visitors processor. The See You Again HTML Paper™ installation process may include displaying a first pop up screen on the visitor display in response to selection of the first link on the vendor web site web page.

See You Again HTML Paper™ computer software provides the facility to automatically download and install a single desktop portal from a web page onto a visitor's computer processor in a single initialization of the software on both the vendor's processor and the visitors processor. See You Again HTML Paper™ software is a desktop portal software program which downloads and installs an HTML file and dependent files on a visitor's processor. This HTML file is comprised of software code to display information and linked elements that load specified web sites.

The “See You Again Screen Saver™” software gives visitors to the vendor's web site, the ability to install a screen saver on the visitor's computer to access the vendor's web site. The screen saver can contain such marketing elements as the vendor's branding, information about the vendor's products and services, company news, special offers, and more. The screen saver may contain images, and other dependent files and may appear on the visitor's display.

The “Windows” (TRADEMARKED) operating system running on the visitor processor will automatically display the screen saver on the visitor's display after a specified amount of idle time.

A graphic button (e.g. “Download See You Again Screen Saver™!”) or any kind of link is typically included on a vendor's web page at which point the visitor could click on it to initiate the See You Again Screen Saver™ installation process.

The present invention in one embodiment includes a method comprising the step of placing a first link on a vendor's web site page of a vendor's web site. The first link can be a graphic button. The method may also include causing a second link which can also be called the See You Again Screen Saver™ link to be placed on a visitor display in response to a “Download Desktop See You Again Screen Saver™” process started by the selection of the first link on the vendor's web site page by a visitor to the vendor's web site page. The selection of the second link or any of the links contained within the See You Again Screen Saver™ on the visitor display, such as with a computer mouse or with a keyboard key, may cause a vendor's web site page of the vendor's web site to be displayed on the visitor display.

The selection of the linked elements contained in the See You Again Screen Saver™ on the visitor display may cause a coupon code, a username and a password, or affiliate identification data to be transferred to a vendor web site server processor, or, in certain cases such as affiliate identification data, the data may be transferred to a separate web site server processor. The See You Again Screen Saver™ installation process may include granting privileges to allow the “See You Again Screen Saver™” software program to make changes to computer software running on the visitor's processor. The See You Again Screen Saver™ installation process may include displaying a first pop up screen on the visitor display in response to selection of the first link on the vendor web site web page.

See You Again Screen Saver™ computer software provides the facility to automatically download and install a screen saver from a web page onto a visitor's computer processor in a single initialization of the software on both the vendor's processor and the visitor's processor. See You Again Screen Saver™ software is a screen saver program which downloads and installs a screen saver file and dependent files on a visitor's processor. This screen saver file is comprised of software code to display information and linked elements that load specified web sites.

The following is a high level overview of various aspects of the present invention in one or more embodiments:

1. See You Again HTML Paper™ software or “See You Again Screen Saver™” software are both computer software which can be downloaded onto a visitor's processor.

2. Either See You Again HTML Paper™ software or “See You Again Screen Saver™” software typically automatically run from a web page once the user initiates the installation process.

3. Either the desktop HTML page or the screen saver is downloaded and typically stored on a visitor's hard drive (where hard drive is part of memory of the visitor processor)

4. The “desktop HTML page file” or “screen saver file” and its dependent files such as images are written to a visitor's hard drive.

5. The desktop HTML page appears, typically, on the Windows Desktop display on the visitor display which causes the desktop HTML Page to be stored in RAM (part of visitor memory) (as this is necessary to consistently display the desktop HTML Page) on the Windows Desktop. The screen saver appears, typically, on the visitor display which causes the screen saver to be stored in RAM (part of visitor memory) (as this is necessary to consistently display the screen saver) on the visitor display.

6. An updateable desktop HTML page or updateable screen saver process also runs on the visitor's computer.

The See You Again HTML Paper™ desktop portal is typically a one-size fits all kind of portal (that is, all users or visitors get the same desktop portal). However, vendors can create multiple desktop portals and install the desktop portal that appeals specifically to specific user segments (i.e. customer bases). They can then use updateable desktop HTML page to update these various portals. Taking this one step further, the desktop portal can even be delivered to customers on an individual basis (e.g. contain some unique information for a specific user such as an order number and order tracking). And, again, the update process can be tailored to deliver updates to specific users.

See You Again Screen Saver™ allows vendors to create multiple screen savers and install the screen saver that appeals specifically to specific user segments (i.e. customer bases). They can then use updateable screen saver to update these various screen savers. Taking this one step further, the screen saver can even be delivered to customers on an individual basis (e.g. contain some unique information for a specific user such as an order number and order tracking). And, again, the update process can be tailored to deliver updates to specific users.

### BRIEF DESCRIPTION OF THE DRAWINGS

FIG. 1 shows a screen for a desktop portal;

FIG. 2 shows an apparatus for implementing various embodiments of the present invention;

FIG. 3 shows a flow chart of a method for allowing a visitor to a web site to put a vendor's desktop HTML page desktop display screen on the visitor's desktop or monitor display in accordance with a first embodiment of the present invention;

FIG. 4A shows a first pop up screen for installing desktop HTML page on a visitor's desktop in accordance with a first embodiment of the present invention;

FIG. 4B shows a second pop up screen for installing desktop HTML page on a visitor's desktop in accordance with a first embodiment of the present invention;

FIG. 4C shows a third pop up screen for installing desktop HTML page on a visitor's desktop in accordance with a first embodiment of the present invention;

FIG. 5 shows a security pop up screen in accordance with a various embodiments of the present invention;

FIG. 6A shows a first pop up screen for uninstalling desktop HTML page on a visitor's desktop in accordance with a first embodiment of the present invention;

FIG. 6B shows a second pop up screen for uninstalling desktop HTML page on a visitor's desktop in accordance with a first embodiment of the present invention;

FIG. 7 shows a sample screen saver in accordance with a second embodiment of the present invention;

FIG. 8 shows a flow chart of a method for allowing a visitor to a web site to put a vendor's screen saver on the visitor's desktop or monitor display in accordance with a second embodiment of the present invention;

FIG. 9A shows a first pop up screen for installing a screen saver on a visitors desktop in accordance with a second embodiment of the present invention;

FIG. 9B shows a second pop up screen for installing a screen saver on a visitor's desktop in accordance with a second embodiment of the present invention;

FIG. 9C shows a third pop up screen for installing a screen saver on a visitor's desktop in accordance with a second embodiment of the present invention;

FIG. 10A shows a first pop up screen for uninstalling a screen saver in accordance with a second embodiment of the present invention;

FIG. 10B shows a second pop up screen for uninstalling a screen saver in accordance with a second embodiment of the present invention; and

FIG. 11 shows a sample vendor web site web page with a link for installing desktop HTML page on the visitor's desktop and a link for installing a screen saver on the visitor's computer.

### DETAILED DESCRIPTION OF THE DRAWINGS

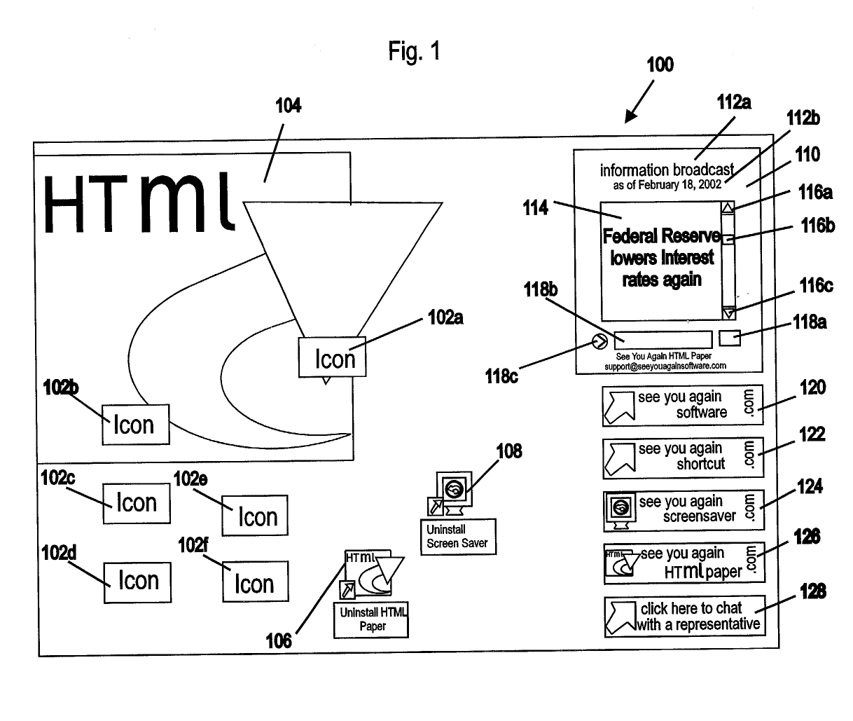

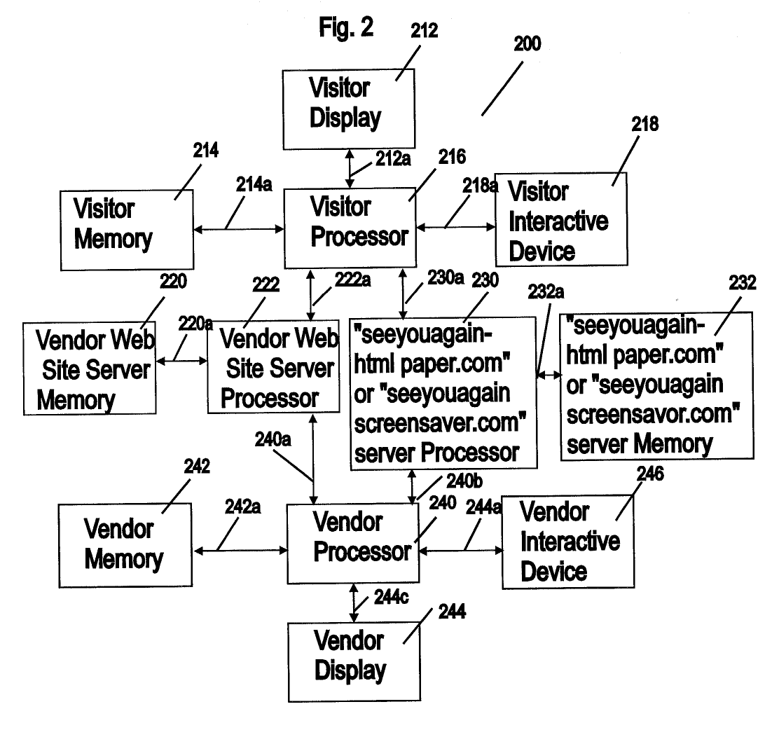

FIG. 1 shows a screen 100 for a desktop portal. The screen 100 may appear on a visitor display or monitor 212 as shown in block diagram 200 of FIG. 2. The screen 100 includes advertising material 104 which may include a vendor company name or logo. The screen 100 is preferably an html (hypertext markup language) page.

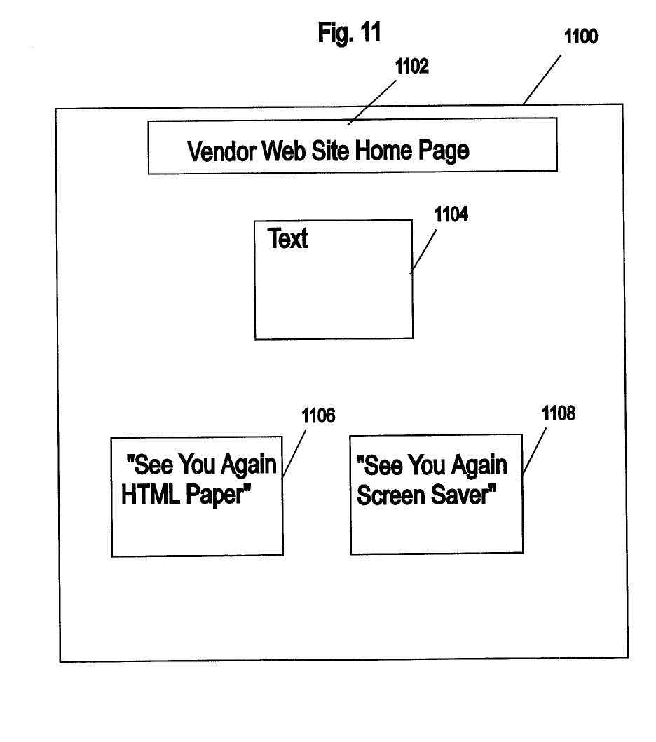

Among other things this means that the screen 100 is an active web page. If one clicks on the advertising material 104, for example, the visitor display will display a web page for a web site for the vendor, such as web page 1100 shown in FIG. 11. The web page 1100 includes text 1102 and 1104.

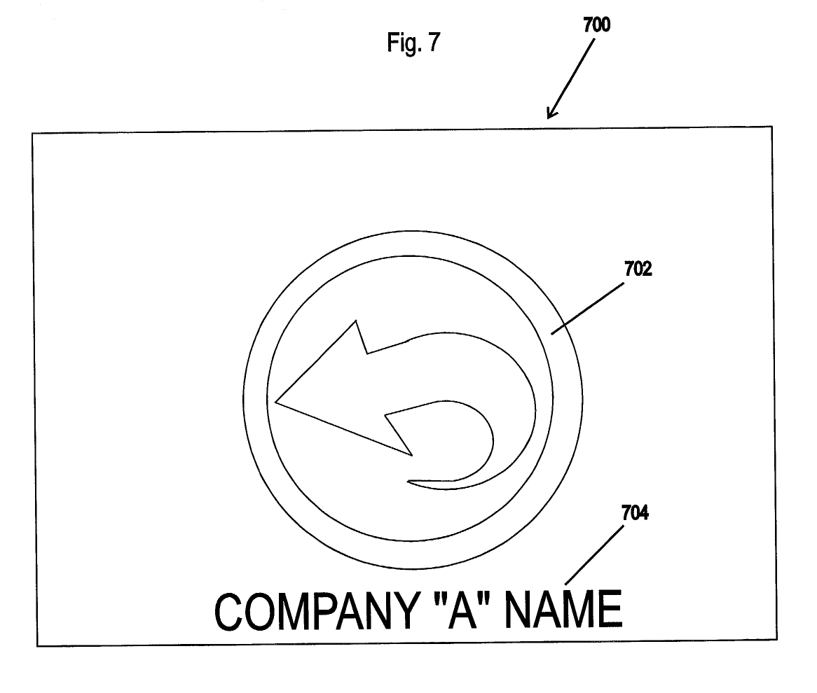

The screen 100 also includes icons 102a, 102b, 102c, 102d, 102e, and 102f, which may be icons that are typically seen on a desktop display screen, such as a WORD (trademarked by Microsoft) Icon. The screen 100 may also include an “uninstall Desktop HTML page” icon or link 106, which when clicked on using a visitor interactive device 218 shown in block diagram form in FIG. 2, may cause the desktop HTML page shown in FIG. 1 to be uninstalled as will be described. The screen 100 may also include an “uninstall Screen Saver” icon or link 108, which when clicked on by interactive device 218 may cause a screen saver shown in FIG. 7 to be uninstalled as will be described. The uninstall Screen Saver icon or link 108 typically only appears on the desktop if the user downloads the screen saver software which has been called See You Again Screen Saver™ computer software.

For example, when a user only downloads and installs See You Again HTML Paper™ computer software, the screen saver and the screen saver uninstall typically do not appear. The screen saver computer software and the desktop HTML page computer software may operate separately. However, it is possible that the screen saver computer software and the desktop HTML page can be combined into one unit and visitors or users may be able to install a desktop portal and screen saver in one shot.

Also part of screen 100 is broadcast window 110. Broadcast window 110 includes a title 112a, the current date 112b, a text box 114, cursor arrows 116a and 116c, and cursor bar 116b, and fields 118a, 118b, and 118c. The text box 114 may display for example current company news which may be provided by the vendor over the internet, for example by using what has been called updateable desktop HTML page and updateable screen saver. The updateable desktop HMTL page and updateable screen saver are comprised of computer software that access the internet to look for a new version of desktop HTML page or screen saver on the vendor's web site server processor 222 or web site server memory 220. If a new version exists, it is downloaded to from the processor 222 to the visitor processor 216 and updated on the visitor processor 216.

The screen 100 includes fields 120, 122, 124, 126, and 128. Each field provides a link to the web site address specified. Screen 100 is just one representation of how a desktop portal may appear.

FIG. 2 shows an apparatus 200 for implementing various embodiments of the present invention. Apparatus 200 is comprised of a visitor display 212, a visitor memory 214, a visitor processor 216, a visitor interactive device 218, a vendor web site server memory 220, a vendor web site server processor 222, a “SeeYouAgainHTMLPaper.com™” and/or “SeeYouAgainScreen Saver.com™” server processor 230, a “SeeYouAgainHTMLPaper.com™” and/or “SeeYouAgain ScreenSaver.com™” server memory 232, a vendor display 240, a vendor memory 242, a vendor processor 244 and a vendor interactive device 246.

Visitor display 212 is electrically connected to visitor processor 216 by bus 212a. Bus 212a and other busses of apparatus 200 may be wireless connections, software connections, hardwire connections, optical connections, or any other method or apparatus known for connecting the various modules. Visitor processor 216 is electrically connected to visitor memory 214 by bus 214a, to visitor interactive device 218 by bus 218a, to vendor web site server processor 222 by bus 222a, and to the a “SeeYouAgainHTMLPaper.com™” and/or “SeeYouAgainScreen Saver.com™” server processor 230 by bus 30a.

Vendor web site server processor 222 is electrically connected by bus 220a to vendor web site server memory 220 and to vendor processor 240 by bus 240a. Server processor 230 is electrically connected to vendor processor 240 by bus 240b. Vendor processor 240 is electrically connected to vendor memory 242 by bus 242a, to vendor display 244 by bus 240a, and to vendor interactive device 246 by bus 244a.

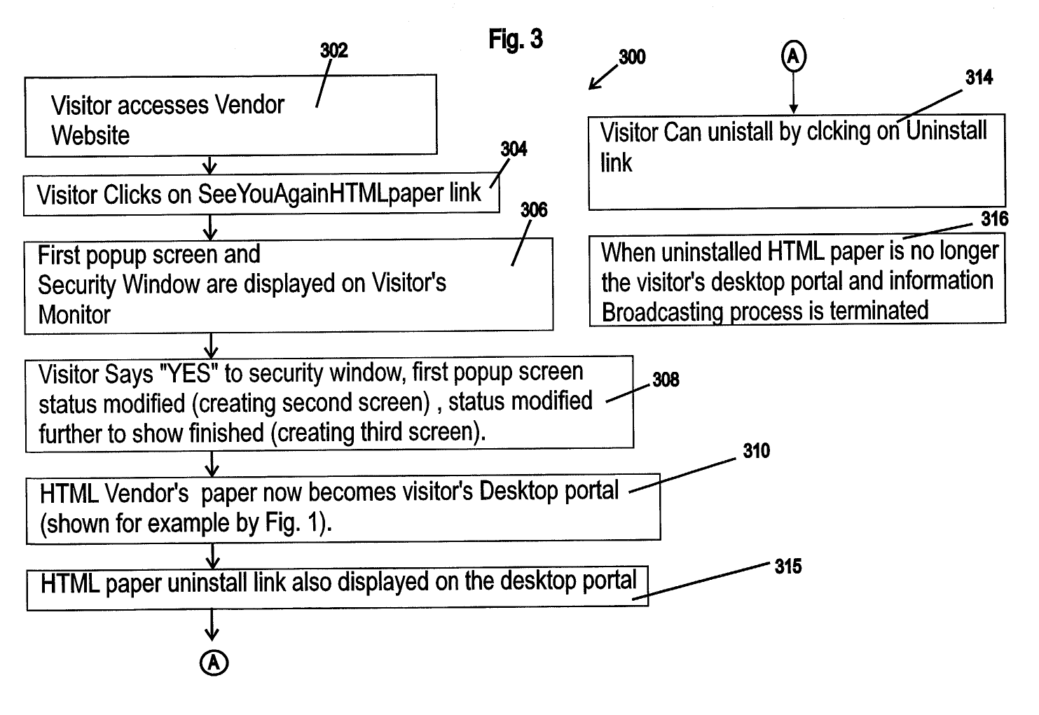

FIG. 3 shows a flow chart 300 of a method for allowing a visitor to a web site to put a vendor's desktop HTML page desktop display screen, such as screen 100, on the visitor's desktop, such as a monitor display, such as visitor's display 212 in accordance with a first embodiment of the present invention.

At step 302 a visitor accesses a vendor's web site web page (such as home page 1100 in FIG. 11) by for example typing in the web site address while in a browser such as “Internet Explorer” (trademarked). The visitor may enter the web site address into the visitor interactive device 218, which may be a keyboard or a computer mouse, or any other known interactive device or combination of interactive devices. This assumes that the particular web site browser has already been activated. The vendor's web site home page, such as page 1100 in FIG. 11, may be displayed on the visitor display 212, in response to the typing in of the address. The vendor's web site home page may be downloaded from the vendor web site memory 220 to the server processor 222 via bus 220a, then to the visitor processor 216 via the bus 222a, and then displayed on the visitor display 212 via bus 212a. The vendor's web site home page may be temporarily stored in the visitor memory 214.

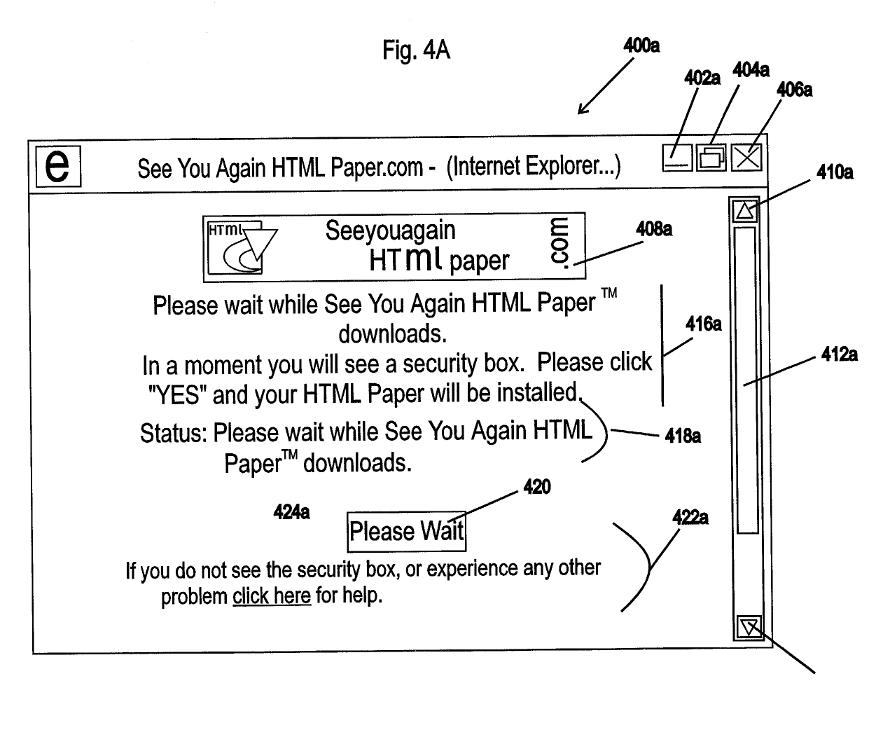

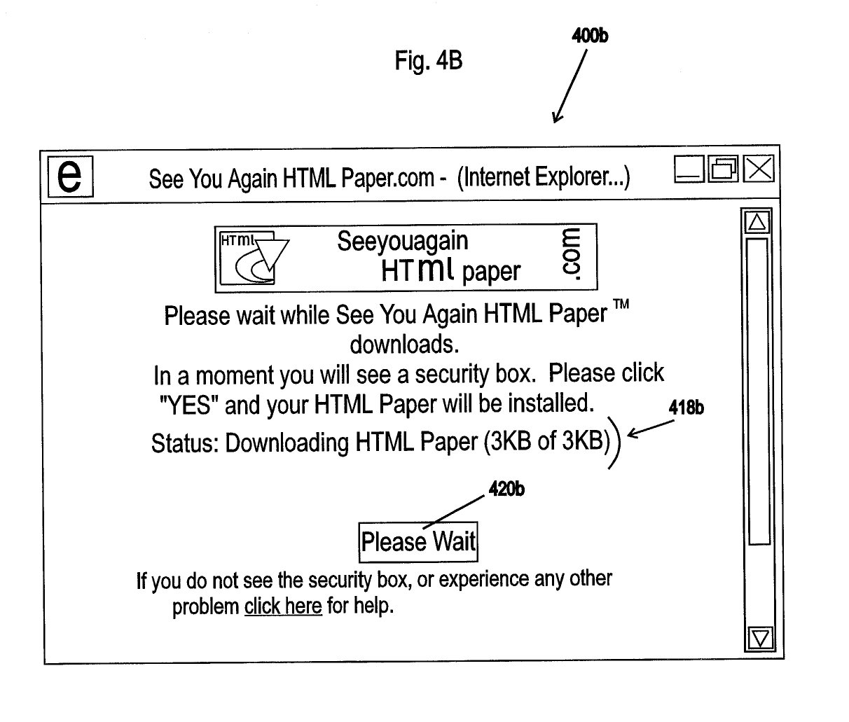

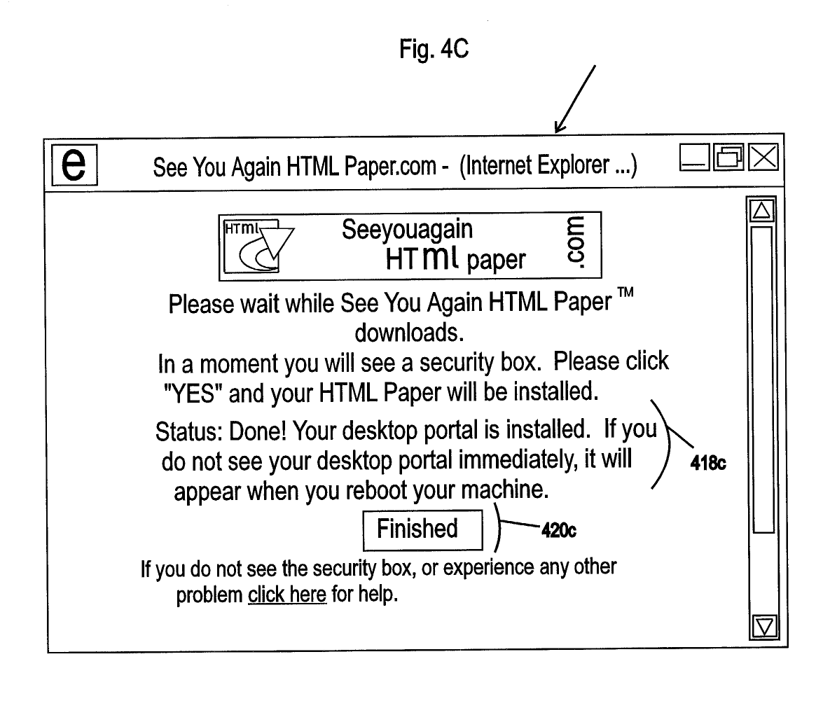

After the vendor's web site is displayed on the visitor's display 212, the visitor clicks on a See You Again HTML Paper™ link, such as link 1106 in FIG. 11, which would be located on the vendor's web site web page, such as on the vendor's home page 1100, at step 304, using the user interactive device 218. This causes a first pop up window 400a shown in FIG. 4A, to be displayed on the visitor display 212 at step 306.

The first pop up window 400a includes typical Windows (trademarked) fields for minimizing, maximizing, and closing a window 402a, 404a, and 406a respectively. The first pop up window 400a also includes text 408a, up and down cursor arrows 410a and 414a, cursor bar 412a, text 416a, text 418a, text 420a, text 422a, and link 424a. The link 424a allows a user to get help. The text 416a indicates that a security box or window will be displayed on the visitor's display 212. The visitor is told to click “YES” on the security window to install a vendor's desktop HTML page.

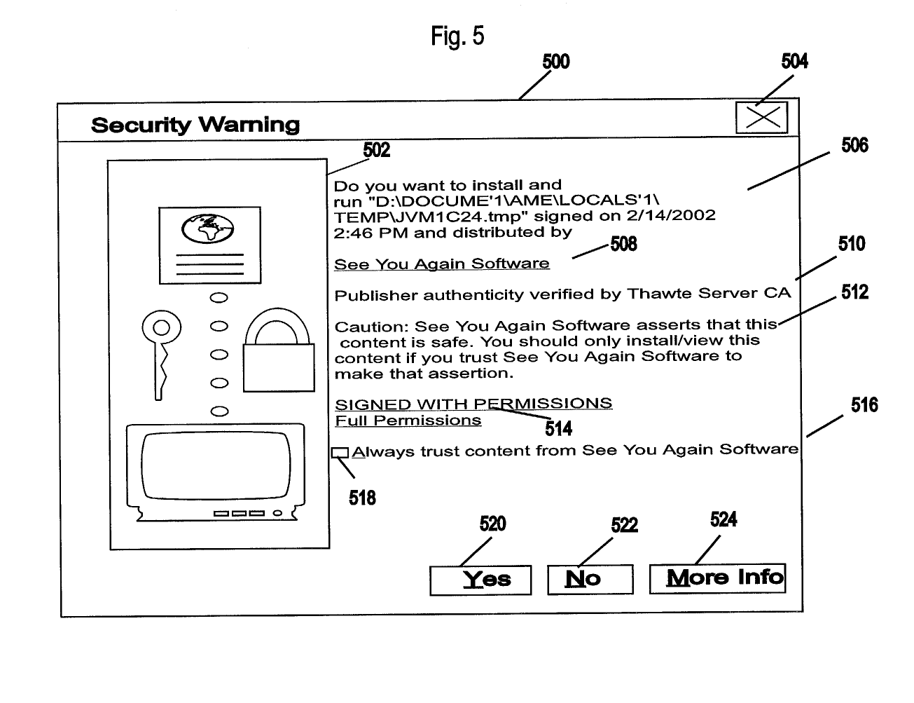

A sample security window or pop up screen 500 is shown in FIG. 5. The pop up menu 400a and security menu 500 may appear at the same time but on different parts of the visitor display 212. The screen 500 includes a close window field 504, graphics 502, and text 506, 510, and 512. The screen 500 also includes a link 508 to the web site for “See You Again Software” and a box 518 to check if content from “See You Again Software” is always to be approved. The screen 500 also includes a “YES” field 520 if the visitor wants to install the vendor's desktop HTML page, a “NO” field 522 if the visitor does not want to install the vendor's desktop HTML page, and a “More Info” field 524 if the user wants more information concerning the vendor's desktop HTML page and installation.

If the visitor clicks on the “YES” field 520, then a second pop up window 400b shown in FIG. 4B is displayed on the visitor's display 212 at step 308. The window 400b may be identical to the window 400a shown in FIG. 4A except that the text 418b for “Status” information in window 400b indicates “Downloading HTML Paper (3KB of 3KB)” whereas the text 418a for “Status” information in window 400a indicates “Please wait while See You Again HTML Paper™ downloads”. “See You Again HTML Paper™” refers to the desktop HTML page computer software in accordance with the present invention. The window 400b may be very briefly displayed depending on the speed of the Internet connection on the visitor processor 216.

The window 400a and the window 400b can be essentially the same window except that the status message dynamically changes to say “Downloading HTML Paper . . . ” etc. when “YES” is clicked on the window 400a. Although not shown in window 400b, since window 400b is a snap shot of an instant in time, typically the status information dynamically shows, in real time the number of kilobytes of data that have been downloaded. There are no known web pages which display real-time download information like this.

To download the desktop HTML page, a desktop HTML page software program is downloaded from either the vendor web site server processor 222 or the server processor 230 to the visitor processor 216 via bus 222a or bus 230a, respectively. A portion of the html software program may be stored in the visitor memory 214. In the case of Internet Explorer (trademarked) the c:\\windows\temp\jvm1C24.tmp file mentioned in the security certificate of FIG. 5 may be stored. A high level overview is that temporary Java files are stored on the visitor's hard drive (in visitor memory 214 or on visitor processor 216) that are then “run” on the visitor processor 216. So, the setup program is typically not stored in the visitor memory 214. However, the ultimate outcome—the code for displaying the desktop HTML page or screen 100 shown in FIG. 1—might be stored in the visitor memory 214 or on the visitor processor 216 as it will in all likelihood be technically a part of the “Windows” (TRADEMARKED) Desktop which is an actively running program on the visitor processor 216. The hard drive may be part of memory which may be part of the visitor processor 216 or the visitor memory 214. At this point the files responsible for the update process are also stored on the visitor processor 216 or the visitor memory.

When the desktop HTML page has been downloaded to the visitor processor 216 a window 400c shown in FIG. 4C is displayed. The window 400c is identical to the window 400a and the window 400b except for status information. The window 400c has a text field 418c which indicates that the desktop portal has been installed and a button 420c which provides the user with the ability to close the window. The result, at step 310, is that the screen 100 shown in FIG. 1 is now the desktop portal (note standard icons 102a-f typically remain on the visitor display 212, regardless of whether desktop HTML page is installed). Strictly speaking if 100 is considered to be the desktop HTML page, then the standard icons 102a-f are not part of the desktop HTML page.

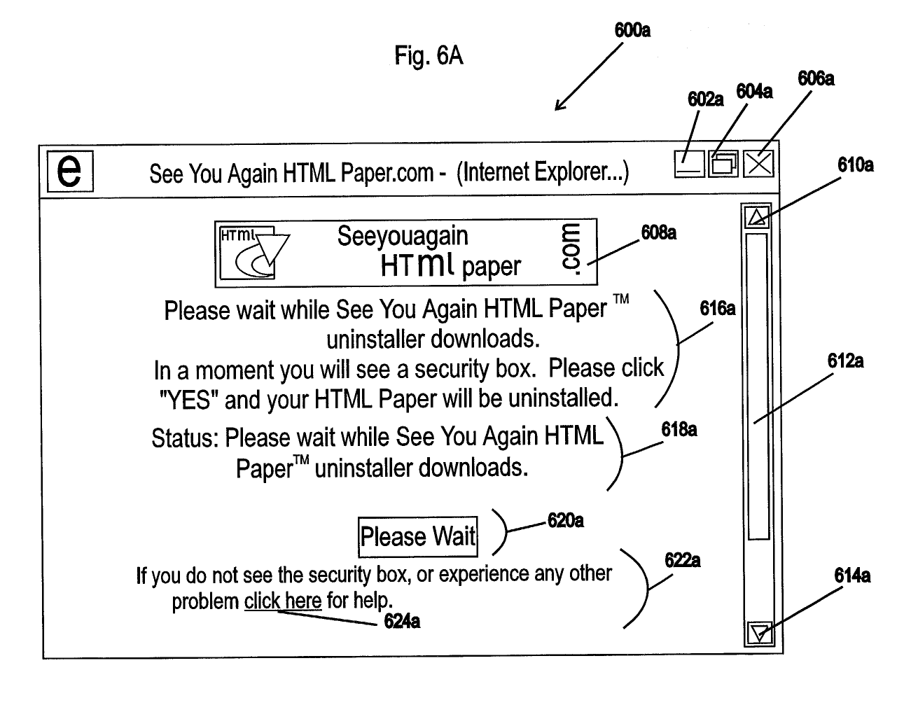

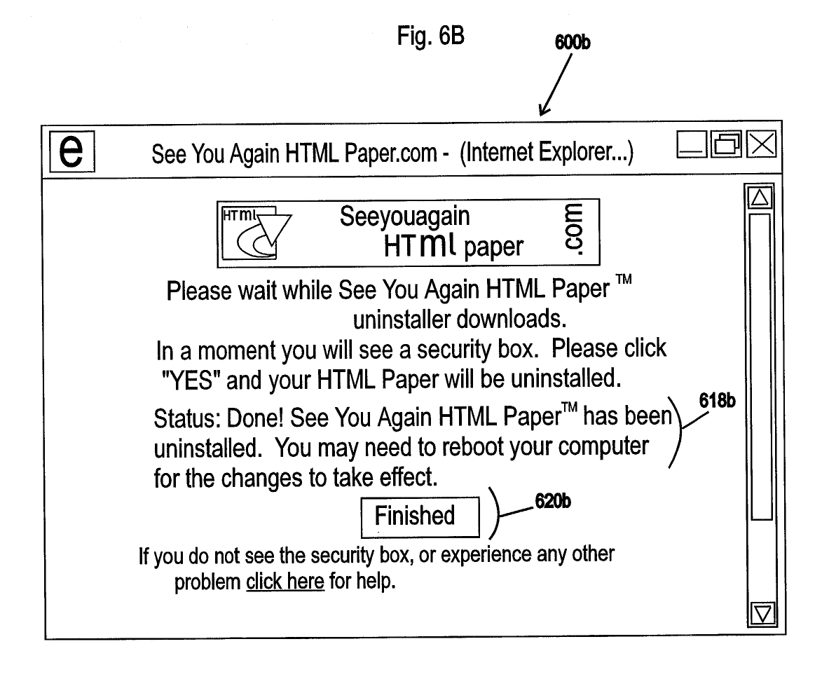

With the installation of the desktop HTML page 100 shown in FIG. 1, an uninstall icon 106 is also installed and displayed at step 312. A visitor can uninstall the desktop HTML page on screen 100 by clicking on the uninstall icon 106 at step 314 in FIG. 3. The desktop HTML page 100 may be automatically uninstalled in response or a pop up window 600a shown in FIG. 6A, may be displayed. The pop up window 600 may be similar to the pop up window 400a in FIG. 4A, with the exception that uninstalling of desktop HTML page is referred to in FIG. 6A, as opposed to installing in FIG. 4A. A security window, similar to that shown in FIG. 5, may appear, and a “YES” authorization may be required, before uninstallation is allowed to occur. After the desktop HTML page is uninstalled, a pop up window 600b shown in FIG. 6B may appear. The pop up window 600b may be similar to pop up window 400c in FIG. 4C, except that FIG. 6B refers to uninstalling while FIG. 4C refers to installing. Note, that installing the desktop HTML page typically does not cause the screen saver to install. Typically the desktop HTML page and screen saver are separate, however, both may be installed.

FIG. 7 shows a sample screen saver 700 in accordance with a second embodiment of the present invention. The sample screen saver 700 may be a screen which appears on the visitor display 212 of FIG. 2, when the visitor interactive device 218 (such as a computer mouse and/or keyboard) has not been used for a certain amount of time. The sample screen saver 700 may include a logo 702 and a name for a company 704 such as the company or vendor of FIG. 2.

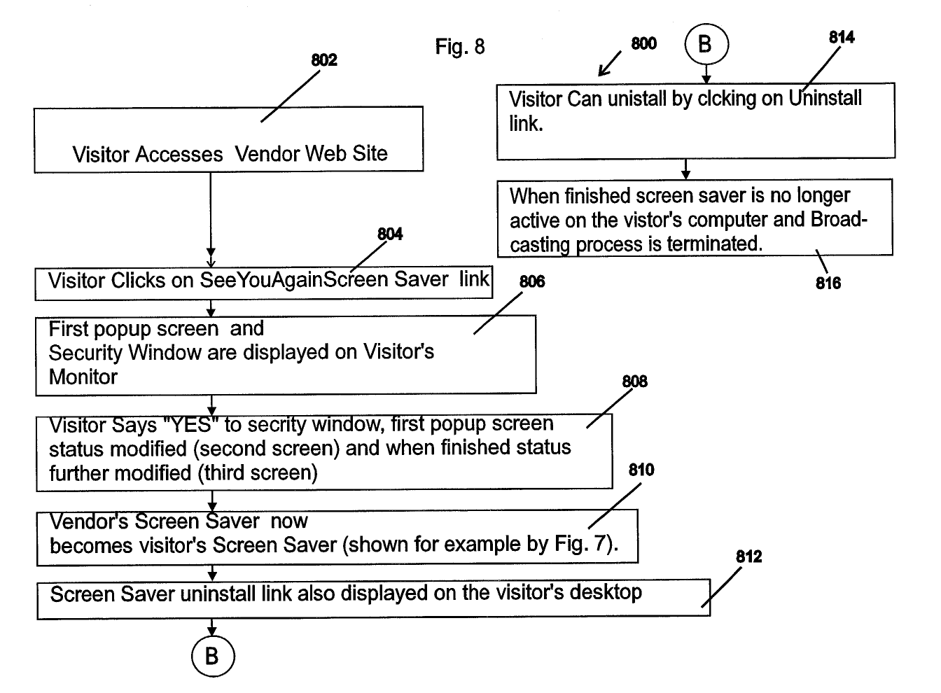

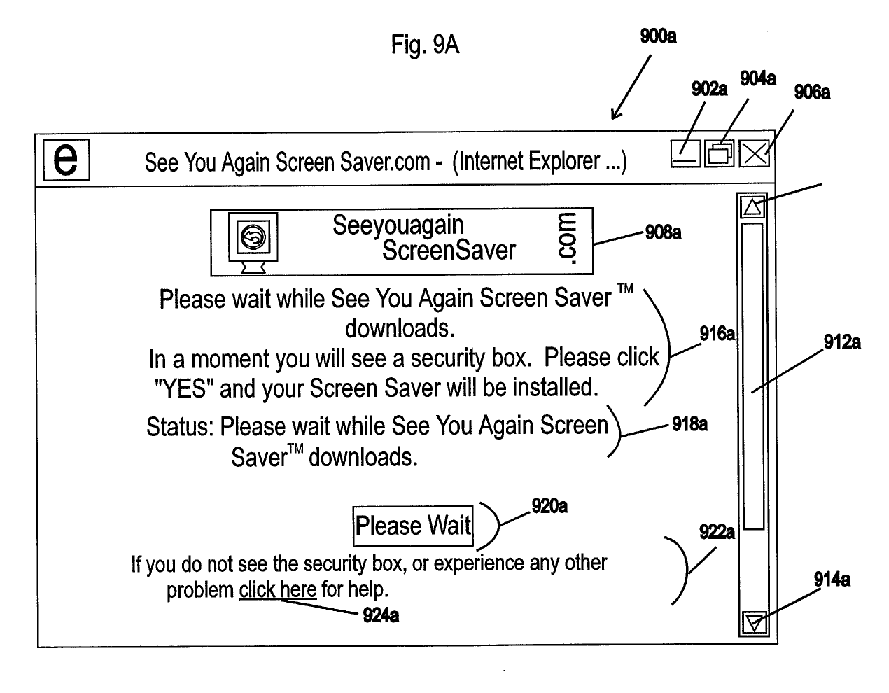

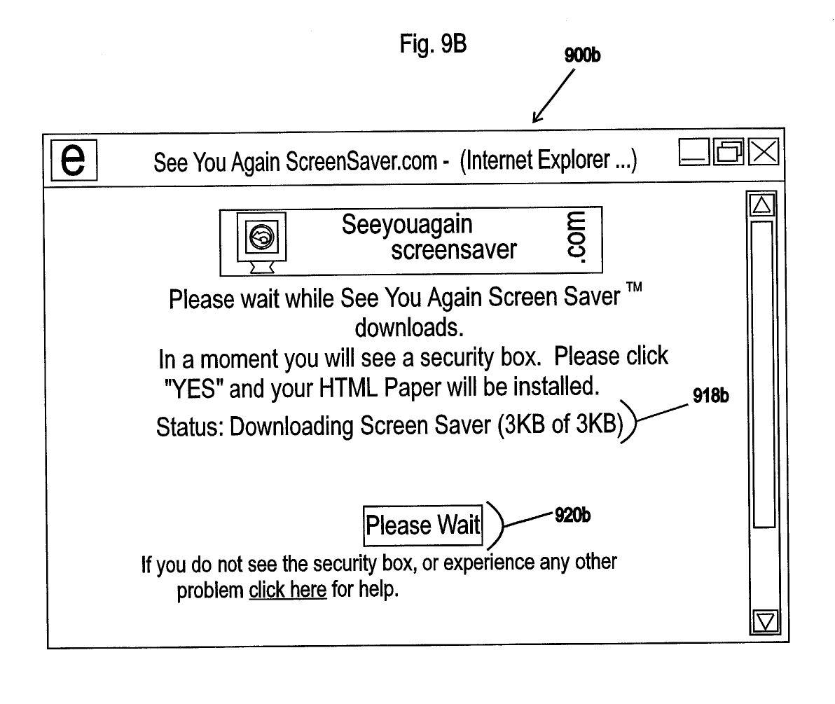

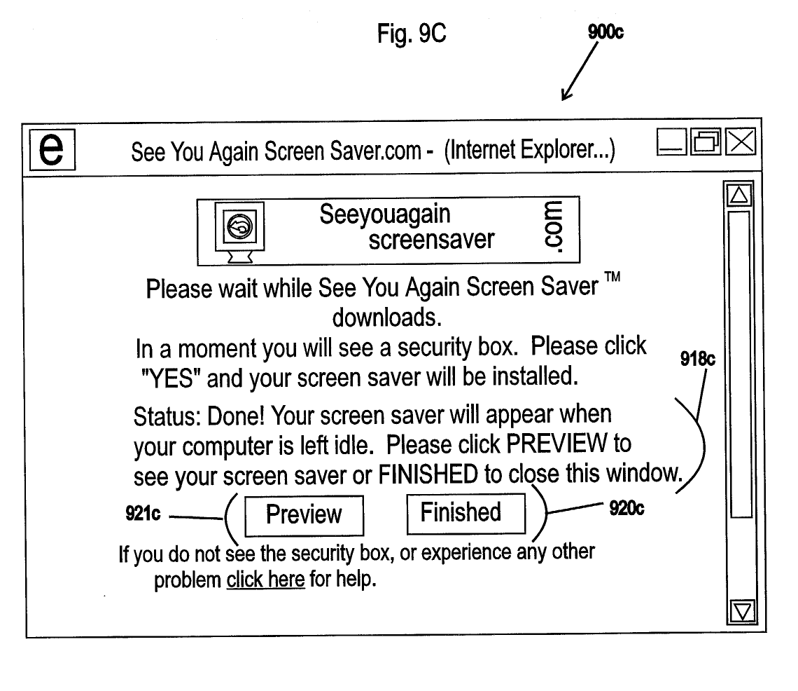

FIG. 8 shows a flow chart 800 of a method for allowing a visitor to a web site to put a vendor's screen saver, such as screen saver 700, on the visitor's desktop display 212 or monitor display in accordance with a second embodiment of the present invention. At step 802 a visitor accesses a vendor's web site by for example typing in the web site name while in a browser such as “Internet Explorer” (trademarked). After the vendor's web site web page is displayed, such as web page 1100, on the visitor's display 212, the visitor clicks on a See You Again Screen Saver link, such as link 1108, at step 804, using the user interactive device 218. This causes a first pop up window 900a shown in FIG. 9A, to be displayed on the visitor display 212 at step 806.

The first pop up window 900a includes typical Windows (trademarked) fields for minimizing, maximizing, and closing a window 902a, 904a, and 906a respectively. The first pop up window 900a also includes text 908a, up and down cursor arrows 910a and 914a, cursor bar 912a, text 916a, text 918a, text 920a, text 922a, and link 924a. The link 924a allows a user to get help. The text 916a indicates that a security box or window will be displayed on the visitor's display 212. The visitor is told to click “YES” on the security window to install a vendor's screen saver. The sample security window or pop up screen 500, shown in FIG. 5, or a slight variation thereof can be used.

If the visitor clicks on the “YES” field 520 in the pop up screen 500 (or a similar field in a similar pop up screen), then a second pop up window 900b shown in FIG. 9B is displayed on the visitor's display 212 at step 808. The window 900b may be identical to the window 900a shown in FIG. 9A except that the text 918b for “Status” information in window 900b indicates “Downloading Screen Saver (3KB of 3KB)” whereas the text 918a for “Status” information in window 900a indicates “Please wait while See You Again Screen Saver™ downloads”. “See You Again Screen Saver™ refers to the screen saver computer software in accordance with another embodiment of the present invention. The window 900b may be very briefly displayed depending on the speed of the Internet connection on the visitor processor 216.

The window 900b may essentially be the same window as the window 900a with only the status information dynamically changing. The “Please wait while See You Again Screen Saver™ downloads” button is inactive to a click by computer mouse and typically dynamically changes to “Finished” after the process completes i.e. window 900c shown in FIG. 9C (if the user clicks Finished the window 900c will close). Windows 900a, 900b and 900c may all essentially be the same window with only the status information dynamically changing.

To download the screen saver, a screen saver software program is downloaded from either the vendor web site server processor 222 or the server processor 230 to the visitor processor 216 via bus 222a or bus 230a, respectively. A portion of the screen saver software program may be stored in the visitor memory 214. In the case of Internet Explorer (trademarked) the c:\\windows\temp\jvm1C24.tmp file mentioned in the security certificate of FIG. 5 may be stored. A high level overview is that temporary Java files are stored on the visitor's hard drive (in visitor memory 214 or on visitor processor 216) that are then “run” on the visitor processor 216. So, the setup program is typically not stored in the visitor memory 214. However, the ultimate outcome—the code for displaying the screen saver 700 shown in FIG. 7—might be stored in the visitor memory 214 or on the visitor processor 216 as it will in all likelihood be technically a part of the “Windows” (TRADEMARKED) computer software which is actively running program on the visitor processor 216. The actual screen saver files (e.g. the .scr file and supporting files) and the files responsible for the update process are stored as well in the visitor processor 216 or visitor memory 214. The hard drive may be part of memory which may be part of the visitor processor 216 or the visitor memory 214.

When the computer software for the screen saver 700 has been downloaded to the visitor processor 216 a window 900c shown in FIG. 9C is displayed. The window 900c is identical to the window 900a and the window 900b except for status information. The window 900c has text field 918c and buttons 920c and 921c. The preview button 920c will display the screen saver on the visitor display 212 and the finished button 921c will close window 900c. The result, at step 810, is that the screen saver 700 shown in FIG. 7 will be displayed on the visitor display 212 during idle time, i.e. typically when the visitor interactive device 218 has not been used for a certain period of time.

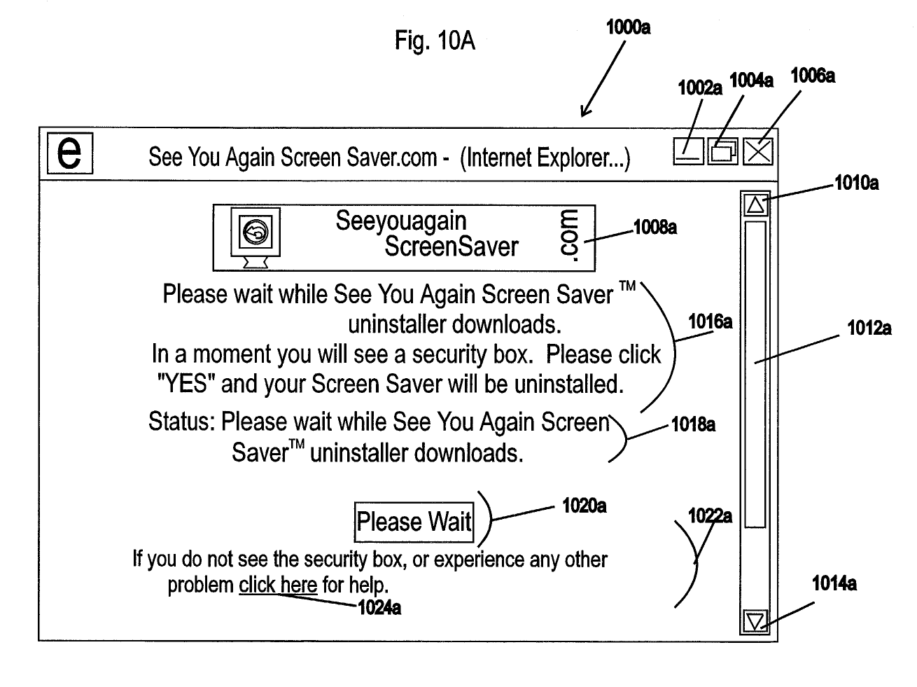

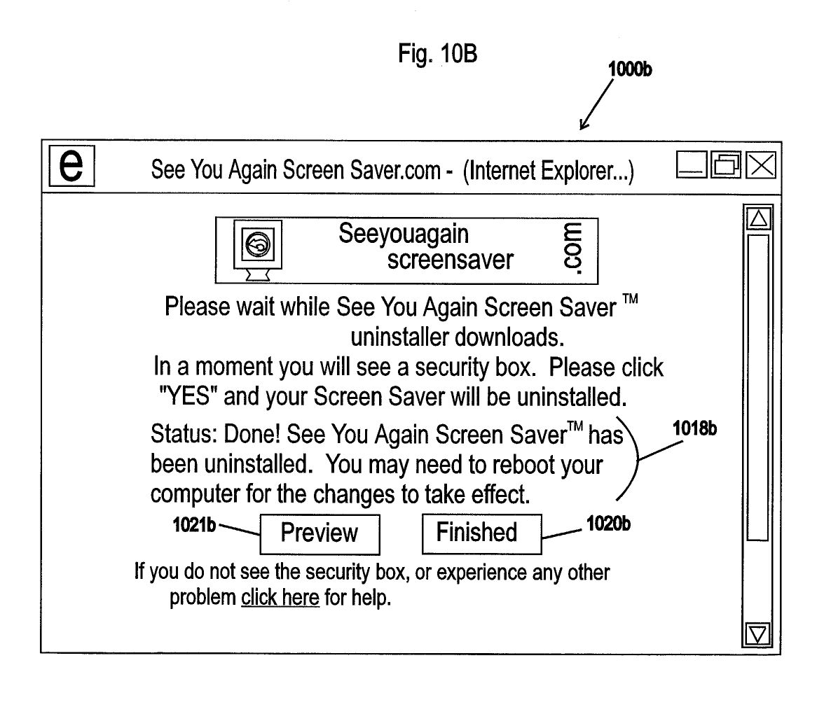

With the installation of the screen saver 700 shown in FIG. 7, an uninstall icon 108 may also be installed and displayed at step 812 of FIG. 8. A visitor can uninstall the screen saver 700 by clicking on the uninstall icon 108 at step 814 in FIG. 8. The computer software for the screen saver 700 may be automatically uninstalled from the visitor's processor 216 in response or a pop up window 1000a shown in FIG. 10A, may be displayed. The pop up window 1000a may be similar to the pop up window 900a in FIG. 9A, with the exception that uninstalling of the screen saver is referred to in FIG. 10A, as opposed to installing in FIG. 9A. A security window, similar to that shown in FIG. 5, may appear, and a “YES” authorization may be required, before uninstallation is allowed to occur. After the screen saver is uninstalled, a pop up window 1000b shown in FIG. 10B may appear. The pop up window 1000b may be similar to pop up window 900c in FIG. 9C, except that FIG. 10B refers to uninstalling while FIG. 9C refers to installing.

The pop up menu 400a and security menu 500 may appear at the same time but on different parts of the visitor display 212. Similarly the pop up menu 900a and a security menu similar to 500 may appear at the same time but on different parts of the visitor display 212.

The “See You Again HTML Paper™” software (i.e. an example of a desktop HTML page computer software in accordance with the present invention) or the “See You Again Screen Saver™” software (i.e. an example of screen saver computer software in accordance with the another embodiment of the present invention) the vendor buys typically sits on the vendor web site server processor 222 and is never executed or “run” on the web site server processor 222 itself. Rather, Java Applets are simply downloaded from the web site server processor 222 (much like a typical HTML page or image is downloaded to a visitor's browser on a visitor processor) and then automatically executed or “run” on the visitor's processor, such as visitor processor 216 in FIG. 2.

Although Java Applets have been used in this example, the Java Applets could be replaced by any computer software application which could be written in a computer programming language such as Visual Basic (TRADEMARKED), C++ (TRADEMARKED), or C# (TRADEMARKED).

The updateable desktop HTML page and updateable screen saver feature allows the vendor to push new information to his customers or visitors at any time simply by updating the vendor's desktop HTML page or the vendor's screen saver and initiating an update process. This provides the vendor with a non-intrusive way to stay in contact with his customers and feature different products, information about his company, offer coupons, and more.

Here is an overview of how updateable desktop HTML page and updateable screen saver works:

1. A visitor comes to the vendor's web site and uses See You Again HTML Paper™ to download and install a desktop HTML page or See You Again Screen Saver™ to install a screen saver right from the vendor's web page.

2. If the vendor enabled updateable desktop HTML page and updateable screen saver, the desktop HTML page and/or the screen saver installed on the visitor's computer processor 16 is “smart enough” to check a control file on the vendor's or vendor's web server processor 22 periodically (typically named “LiveUpdate.txt”) to see if a new version of itself exists. The version number does not need to be higher, simply different. The update process may run every so often, such as every 15 minutes whether or not an Internet connection is present.

Here is a more detailed description of what the See You Again HTML Paper™ update files do:

syasstartuphp.exe: File that initiates the Live Update process.

syasrefreshhp.exe: File that refreshes the user's Windows Desktop after an updated version of a desktop HTML page in accordance with the present invention is downloaded.

syasrunnerhp.class: File that runs continuously and calls syasliveupdatehp.class every 15 minutes.

syasliveupdatehp.class: File that checks the control file on the vendor web server processor 22 (typically “LiveUpdate.txt”) to compare the version number contained in that file with the current version number stored in the user's registry. This file is also responsible for downloading the updated desktop HTML page to the visitor processor 16 and calling syasrefresh.exe to refresh the visitor desktop and visitor display 12.

Note that for See You Again Screen Saver™ there is no “syasrefreshhp.exe” file. In addition, “syasstartuphp.exe” is named “syascreensaverstartup.exe”, “syasrunnerhp.class” is named “syasrunner.class”, and “syasliveupdatehp.class” is named “syasliveupdate.class”.

3. If Live Update checks for a new version and it does not exist, no download occurs.

4. If Live Update checks for a new version and it does exist, the new Desktop HTML page in accordance with the present invention or the new screen saver in accordance with the second embodiment of the present invention is quickly and seamlessly downloaded in the background.

5. The updated desktop HTML page replaces the old version and the visitor's Windows (trademarked) Desktop is refreshed so it reflects the updated version.

6. The Live Update process is quiet and seamless. The user or visitor is never bothered with participating in the update process.

In summary, the desktop HTML page provided by the vendor through the vendor web site may have the option of being a live desktop portal that the vendor can update at any time. In addition, the screen saver provided by the vendor through the vendor web site may have the option of being a live screen saver that the vendor can update at any time.

The following is a description of each file you should find in sya_htmlpaper_files.zip for installing desktop HTML page computer software in accordance with the present invention on visitor processor 16.

File Descriptions:

default.htm: This web page contains Javascript that detects the user's or visitor's browser version and level to ensure that Internet Explorer 4.0 or higher is being used before proceeding. If the appropriate browser is not being used the user is redirected to the “browser_not_valid.htm” page. If the appropriate browser is being used the user is redirected to the “iecab.htm” page to download See You Again HTML Paper™ computer software.

browser_not_valid.htm: The page that informs the user or visitor they need to use Internet Explorer 4.0 or higher.

iecab.htm: The page that downloads See You Again HTML Paper™ computer software for Internet Explorer (TRADEMARKED) and provides the user with a confirmation.

uninstall.htm: The page that uninstalls See You Again HTML Paper™ computer software from the visitor's computer processor 16 if the user chooses to uninstall.

uninstall_instructions.htm: The page that contains manual instructions on how to uninstall See You Again HTML Paper™ computer software in case the user wishes to uninstall the software manually.

seeyouagainsoftwareie.cab: The compressed and digitally signed See You Again HTML Paper™ software that will be downloaded for Internet Explorer (trademarked) browsers.

a.class: The class file that needs to be included for Internet Explorer (trademarked).

syasstartuphp.exe: File that enables updateable desktop HTML page and updateable screen saver to a vendor's web site users through live update technology.

syasrefreshhp.exe: File that enables updateable desktop HTML page and updateable screen saver to a vendor's web site users through live update technology.

syasrunnerhp.class: File that enables updateable desktop HTML page and updateable screen saver to a vendor's web site users through live update technology.

syasliveupdatehp.class: File that enables updateable desktop HTML page and updateable screen saver to a vendor's web site users through live update technology.

syaslogo.gif: The See You Again HTML Paper™ logo.

hpuninstall.ico: The uninstall icon that is placed on the user's or visitor's Windows Desktop of the visitor display 212 that links to the See You Again HTML Paper™ computer software uninstall web page.

The following is a method of installation for installing desktop HTML page computer software on a visitor processor 216 in accordance with the present invention.

Step 1-Make sure the vendor's See You Again HTML Paper™ is ready:

1. The vendor's See You Again HTML Paper™ may be a specially modified HTML page that may act as the visitor's desktop portal. The visitor can then do anything on the desktop HTML page in accordance with the present invention that the visitor can do in regular HTML. Plus, since desktop HTML page is powered by Internet Explorer (trademarked) the visitor can also take full advantage of Microsoft's (trademarked) powerful dynamic HTML capabilities. Typically the special modification required is that the visitor does not specify any path information for images or other support files contained in your HTML page. The HTML page itself and the dependent images are stored on the visitor's local hard drive (such as memory 214 or on processor 216). Therefore, the HTML must be looking for the images in the directory where the HTML file is stored. The simple way to accomplish this is to remove any path information from the image tags. So, for example, if the vendor's desktop HTML page contained an image called “image1.gif” the image tag in the vendor's HTML should be as follows:

<img src=“image1.gif”>

The vendor should go through the vendor's desktop HTML page carefully in order to remove any path information for each image. To make it easy to locate all of the vendor's images it is recommended that a “Find” be done for the codes of “.gif” and “.jpg”.

Step 2-Edit Parameter List

The vendor should open iecab.htm and edit the HTML parameter list. This is where the vendor should specify where the vendor's desktop HTML page files are located as well as other information. Please note that the values for the “param name=” values are case-sensitive (e.g. param name=HTMLPaperPath).

Specify the path where the vendor's desktop HTML page files Are Located:

<param name=“HTMLPaperPath” value=“http://www.yourwebsiteURL.com/sya_htmlpaper/”>

Specify each file of the vendor's desktop HTML page: (separate each with a comma, no spaces)

<param name=“HTMLPaperFiles” value=“default.htm,image1.gif,image2.gif,image3.jpg”>

Specify the folder Where the vendor's desktop HTML page will reside on the visitor or user's Computer:

<param name=“HTMLPaperFolder” value=“yoursitename”>

The name of the vendor's folder should be unique. The inventor recommends using the name of the vendor's web site (e.g. “yoursitename”). In this example, the ultimate destination of the vendor's desktop HTML page on the visitor's hard drive, such as memory 214 or processor 216, would be “c:\windows\syas\yoursitename”)

Specify the status message the user or visitor sees while desktop HTML page computer software in accordance with the present invention downloads:

<param name=“HTMLPaperStatusMessage” value=“Downloading desktop HTML page”>

Specify Download Counter True or False

<param name=“DownloadCounter” value=“true”>

The download counter displays the number of kilobytes that have downloaded to the user.

Specify the Status Message The User or Visitor Sees When the computer softwar for the desktop HTML page Is Installed:

<param name=“DoneStatus” value=“Done! Your Desktop HTML page is installed!”>

Note: This is the message the user or visitor sees on the visitor display 212 when the desktop HTML page computer software has finished downloading and is installed on the visitor processor 216.

Specify HTMLPaperLiveUpdate Either True or False

<param name=“HTMLPaperLiveUpdate” value=“true”>

Note: If the vendor enables this option the vendor can broadcast up-to-date information to the vendor's users simply by updating the vendor's desktop HTML page!

When the vendor does this everyone who has the vendor's desktop HTML page installed will automatically receive the update.

Specify the Value of the Current Live Update Version:

<param name=“HTMLPaperLiveUpdateVersion” value=“1”>

Note: Since the vendor is just starting out the value of this number should be “1”.

In the future, typically every time the vendor releases an updated version of the vendor's desktop HTML page the vendor must change this number to the latest version number.

Specify the Path Where the vendor's LiveUpdate Control File Is Located:

<param name=“HTMLPaperLiveUpdatePath”

value=“http://www.yourwebsiteURL.com/sya_htmlpaper/”>

Note: This is the path where the LiveUpdate control file can be found. The value for this parameter is typically the same value that the vendor gave “HTMLPaperPath”. The vendor should make sure that the vendor *never* renames this folder on the vendor's web site server memory 20 as the visitor's desktop HTML page on the visitor processor 16 will be looking for the Live Update control file in this directory. If this path cannot be found the LiveUpdate cannot occur.

Specify the Name of the Live Update Control File:

<param name=“HTMLPaperLiveUpdateFile” value=“liveupdate.txt”>

Note: This is the plain-text Live Update control file that contains information about where the vendor's latest desktop HTML page files can be downloaded from. The vendor can use whatever filename the vendor likes. However, once the vendor decides on a filename, the vendor should make sure typically to ‘never’ to change the name as the visitor's desktop HTML page on the processor 16 will be looking for this particular filename. If this file cannot be found the live update cannot occur.

Specify HTMLPaperUninstallOption Either True or False:

<param name=“HTMLPaperUninstallOption” value=“true”>

Note: Setting this option to “true” will place an uninstall icon on the user's or visitor's Windows Desktop on visitor display 12 that links to the uninstall page. It is recommended that the vendor set this option to “true” so the visitor has a way to uninstall the vendor's desktop HTML page if the visitor chooses to do so.

Specify the Name Associated With the Uninstall Icon:

<param name=“HTMLPaperUninstallName” value=“Uninstall Desktop HTML page”>

Note: This is the text caption that will appear underneath the vendor's uninstall icon.

Specify the Name of the Uninstall File:

<param name=“HTMLPaperUninstallFile” value=“uninstall.htm”>

Note: This is the page that uninstalls the desktop HTML page (also called “HTML Paper”) from the visitor's computer if the visitor chooses to uninstall. The uninstall.htm file should be located in the “sya_htmlpaper” folder (you will create this folder in Step 4).

Specify the Filename of the Uninstall Icon: <param name=“HTMLPaperUninstallIcon” value=“hpuninstall.ico”>

Note: This is the uninstall icon that is placed on the visitor's Windows Desktop on visitor display 212 that links to the See You Again HTML paper™ uninstall web page. The uninstall icon should be located in the “sya_htmlpaper” folder (the vendor will create this folder in Step 4).

Once the vendor is finished editing the above parameters the vendor can save the vendor's iecab.htm file.

>>A note about the uninstall.htm file: The uninstall.htm file is the page that automatically uninstalls the desktop HTML page (i.e. the HTML paper) from the visitor's or user's computer processor 216 if the user or visitor chooses to uninstall. It contains the following two parameters:

Specify HTMLPaperUninstallNow Either True or False:

<param name=“HTMLPaperUninstallNow” value=“true”>

Note: In the uninstall.htm file this parameter should always be set to “true”. Never include this parameter in the iecab.htm file.

Specify the Status Message The User Sees When the Uninstallation Is Complete <param name=“DoneStatus” value=“Done! See You Again HTML paper™ has been uninstalled. The vendor may need to reboot the vendor's computer processor 240 for the changes to take effect.”>

The above parameters for uninstall.htm are already preconfigured so the vendor does not need to edit this file.

Step 3-Edit the LiveUpdate File: (Only Complete this step if the vendor wants to use Live Update).

LiveUpdate allows the vendor to broadcast up-to-date information to the vendor's visitors or users simply by updating the vendor's desktop HTML page! When the vendor does the update everyone who has the vendor's desktop HTML page installed will automatically receive the update.

Open “liveupdate.txt” and edit the three parameter lines. In this file you specify the version number of the vendor's desktop HTML page and where the vendor's latest desktop HTML page files can be downloaded from.

Line 1: Version Number 1

Note: Every time the vendor updates the vendor's desktop HTML page the vendor must change the version number. Changing the version number signals the desktop HTML page to download the vendor's latest version. The vendor can use any numbering scheme though it is suggested to start at “1” and increment each version by 1.

When the vendor releases a new version the vendor should be sure to update the value of the “HTMLPaperLiveUpdateVersion” parameter in the vendor's “iecab.htm” file.

Line 2: Specify the path where the vendor's latest desktop HTML page files are located:

http://www.vendorwebsiteURL.com/sya_htmlpaper/

Note: This can be the same value of the “HTMLPaperPath” parameter in the vendor's “iecab.htm” file if the vendor plans on keeping your latest desktop HTML page files in that directory.

Line 3: Specify each file of the vendor's latest desktop HTML page: (separate each with a comma, no spaces)

default.htm,image1.gif,image2.gif,image3.jpg

Note: This file list may be different from the original value specified in the “HTMLPaperFiles” parameter in the vendor's “iecab.htm” file since the latest version of the vendor's desktop HTML page might contain new files. However, the filename of the actual HTML file (in the above example “default.htm”) must remain the same as the filename the vendor specified in the “HTMLPaperFiles” parameters. This is because if the vendor changes the name of the HTML file a “new” desktop HTML page will be downloaded as opposed to “updating” the existing desktop HTML page that is already installed.

Step 4-Upload Files

Upload all the files listed above to the vendor's web server processor 222. It is recommended that the vendor place these files under one directory in a folder named “sya_htmlpaper”. If the vendor decided to create the vendor's own directory structure (including subfolders) the vendor will need to edit the HTML files and change the paths to the files.

Step 5-Activate See You Again HTML Paper”

See You Again HTML Paper™ computer software (i.e. one example of the computer software for desktop HTML page in accordance with the present invention) can be activated two ways. We recommend using both methods:

1. Place a button or text link on the vendor's site web page that your user or visitor can click on

2. Begin an “Automatic Initialization” of See You Again HTML Paper™ the first time a visitor comes to your web site.

1. Button or text link

The vendor can use one of the following three links to get visitors to the vendor's web site to activate See You Again HTML Paper™. Simply copy and paste the HTML link code into every web page of the vendor's web site that the vendor wants to link to See You Again HTML Paper™. To maximize your Desktop HTML Paper™ conversions it is recommended to place these links on every web page of the vendor web site.

Note: The vendor may create and use the vendor's own button or text link.

Button:

Please right click on the above image and save it as “sya_htmlpaper_dl.gif” to the vendor's hard drive such as on the vendor processor 240. Here is the code the vendor can copy and paste into the vendor's web page to link the horizontal button to See You Again HTML Paper™. The vendor should make sure that the vendor scrolls the vendor's cursor all the way to the bottom of the textbox to ensure the vendor is copying all the code. The vendor should replace “www.vendorsite.com” with the vendor's real domain name.

<a
href=“javascript:void(window.open(‘httP://www.yoursite.com/sya_htmlpaper/default.htm’,
‘HTML Paper’,‘alwaysRaised=yes,resizable=yes,scrollbars=yes,Width=350,height=350,
Ieft=100,top=100,screenX=100screenY=100’));”>
<img src=“http://www.yoursite.com/sya_htmlpaper/sya_htmlpaper_dl.gif”
alt=“Install our Desktop Portal!” border=“0”></a>

Text Link

Here is the code the vendor can copy and paste into the vendor's web site web page to link text to See You Again HTML paper™. The vendor should make sure that the vendor scrolls the vendor's cursor all the way to the bottom of the textbox to ensure that the vendor is copying all the code. Remember to replace “www.vendorsite.com” with the vendor's real domain name.

Download our HTML paper™! Click <a

href=“javascript:void(window.open(‘http://www.yoursite.com/sya_htmlpaper/default.htm’,‘HTMLPaper’,‘alwaysRaised=yes,resizable=yes,scrollbars=yes,width=350,height=350,left=100,top=100,screenX=100,screenY=100’));”>here</a>to install our desktop portal!

2. AUTOMATIC INITIALIZATION (Maximize Your HTML paper™ Conversions)

It is recommended that automatic initialization be used by a vendor to maximize the vendor's desktop HTML page conversions. Here's how it works. The first time a visitor comes to a vendor's homepage a popup box may appear prompting the visitor to download the visitor's desktop HTML page. At this point the visitor has a 50/50 chance of getting the desktop HTML page conversion. So, for example, if the vendor web site gets five hundred unique visitors a day the vendor will land about two hundred and fifty desktop HTML page installations a day. Using this technique a vendor will quickly and easily install thousands and thousands of a vendor's desktop HTML page. Your visitor is only automatically prompted a single time so this technique is not obtrusive.

The vendor may need to add the following javascript code to every web page the vendor wants automatic initialization to occur. It is recommended to place this javascript code between the opening and closing HEAD tags (e.g. <HEAD> </HEAD>) which are located near the top of the vendor's HTML page. The vendor should make sure that the vendor scrolls the vendor's cursor all the way to the bottom of the textbox to ensure that the vendor is copying all the code. The vendor should replace “www.vendorsite.com” with the vendor's real domain name.

<scriptlIanguage=“Javascript”>
<!--
//If the cookie does not exist this is a first time visit
if (document.cookie.indexOf(“popup=true”) == −1) {

expireDate = new Date
expireDate.setMonth(expireDate.getMonth( )+24)
document.cookie = “popup=true; expires=” + expireDate.toGMTString( );
//popup the window
window.open(‘http://www.yoursite.com/sya_htmlpaper/default.htm’,‘HTMLPaper’,‘always

Raised=yes,resizable=yes,scrollbars=yes,width=350,height=350,left=100,top=100,screenX=10
0,screen Y = 100’)
}
// -->
</script>

Step 6-Display Method

If the vendor wants See You Again HTML Paper™ to appear in a default popup box on a web page of the vendor's web site then the vendor would skip this step. To make See You Again HTML Paper™ show up in the main window of a web page on the vendor's web site, and not in a popup window, the vendor would change the following javascript portion in the vendor's link code. The vendor should make sure to scroll the vendor's cursor all the way to the bottom of the textbox to ensure that the vendor copies all the code. The vendor should replace “www.vendorsite.com” with the vendor's real domain name.

From:

javascript:void(window.open(‘http://www.yoursite.com/sya_htmlpaper/default.htm’,‘HTMLPaper’,‘alwaysRaised=yes,resizable=yes,scrollbars=yes,width=350,height=350,left=100,top=100,screenX=100,screenY=100’));

To:

javascript:void(window.location.href=(‘http://www.yoursite.com/sya_htmlpaper/default.htm’));

Step 7-Troubleshooting

See You Again HTML Paper™ computer software ships with a convenient diagnostic tool that will help the vendor identify the cause of any problems a vendor may experience.

Internet Explorer (TRADEMARKED)

To open the diagnostic tool in Internet Explorer (TRADEMARKED) go to Tools/Internet Options/ and click on the Advanced tab. Then the vendor should scroll about half way down to the Java category and make sure the following option is checked:

Java console enabled (requires restart)

The vendor should then shut the vendor's browser down and open it again.

Next the vendor should run through the shortcut creation process on the vendor's web site. After the vendor gets the message the “Done!” then the vendor should go to View/Java console in the vendor browser. This will open the diagnostic output window and allow the vendor to see exactly what is happening inside the computer program application. In most cases the vendor will be able to spot what is wrong simply by reading the output. However, if the vendor cannot determine what is wrong the vendor can copy and paste the diagnostic output into an e-mail and send it to a support staff.

The following is a description of each file you should find in sya_screensaver_files.zip for installing screen saver computer software in accordance with the present invention on visitor processor 16.

If you do not wish to read the file descriptions, please skip straight to the installation instructions.

File Descriptions

default.htm: The page contains Javascript that detects the user's browser version and level to ensure that Internet Explorer 4.0 and higher is being used before proceeding. If the appropriate browser is not being used the user is redirected to the “browser_not_valid.htm” page. If the appropriate browser is being used the user is redirected to the “iecab.htm” page to download See You Again Screen Saver™.

browser_not_valid.htm: The page that informs the user they need to use Internet Explorer 4.0 or higher.

iecab.htm: The page that downloads See You Again Screen Saver™ for Internet Explorer and provides the user with a confirmation.

uninstall.htm: The page that automatically uninstalls See You Again Screen Saver™ from the user's computer if the user chooses to uninstall.

uninstall_instructions.htm: The page that contains manual instructions on how to uninstall See You Again Screen Saver™ in case the user wishes to uninstall the software manually.

seeyouagainsoftwareie.cab: The compressed and digitally signed See You Again Screen Saver™ software that will be downloaded for IE browsers.

a.class: The class file that needs to be included for Internet Explorer.

syascreensaverstartup.exe: File that enables Information Broadcasting to your users through our LiveUpdate technology.

syasrunner.class: File that enables Information Broadcasting to your users through our LiveUpdate technology.

syasliveupdate.class: File that enables Information Broadcasting to your users through our LiveUpdate technology.

syaslogo.gif: The See You Again Screen Saver™ logo.

ssuninstall.ico: The uninstall icon that is placed on the user's Windows Desktop that links to the See You Again Screen Saver™ uninstall page.

Installation

Step 1-Edit Parameter List

Open iecab.htm and edit the HTML parameter list. This is where you specify where your screen saver files are located as well as other information. Please note that the values for the “param name=” values are case-sensitive (e.g. param name=ScreenSaverPath).

Specify the Path Where Your Screen Saver Files Are Located:

<param name=“ScreenSaverPath”

value=“http://www.yourwebsiteURL.com/sya_screensaver/”>

Specify Each File of Your Screen Saver: (separate each with a comma, no spaces)

<param name=“ScreenSaverFiles” value=“file1.scr,file2.dat”>

Note: Most screen savers are comprised of an .scr file and a .dat file

Specify the Number of Seconds Before Screen Saver Appears

<param name=“ScreenSaverTimeOut” value=“300”>

Note: In the above example, 300 seconds is 5 minutes.

Specify the Status Message The User Sees While Screen Saver Downloads

<param name=“ScreenSaverStatusMessage” value=“Downloading Screen Saver”>

Specify Auto Preview Either True or False

<param name=“ScreenSaverAutoPreview” value=“true”>

Note: Auto Preview means the screen saver will automatically appear as soon as the download is finished.

Specify Preview Button Either True or False

<param name=“ScreenSaverPreviewButton” value=“true”>

Note: The Preview Button allows the user to preview the screen saver directly from the web page.

Specify Download Counter True or False

<param name=“DownloadCounter” value=“true”>

Note: The download counter displays the number of kilobytes that have downloaded to the user.

Specify the Status Message The User Sees When Screen Saver Is Installed

<param name=“DoneStatus” value=“Done! Your screen saver will appear when your computer is left idle. Please click PREVIEW to see your screen saver or FINISHED to close this window.”>

Note: This is the message the user sees when the screen saver has finished downloading and is installed.

Specify ScreenSaverLiveUpdate Either True or False

<param name=“ScreenSaverLiveUpdate” value=“true”>

Note: If you enable this option you can broadcast up-to-date information to your users simply by updating your screen saver! When you do this everyone who has your screen saver installed will automatically receive the update.

Specify the Value of the Current LiveUpdate Version:

<param name=“ScreenSaverLiveUpdateVersion” value=“1”>

Note: Since you are just starting out the value of this number should be “1”. Important: In the future, every time you release an updated version of your screen saver you must change this number to the latest version number.

Specify the Path Where Your LiveUpdate Control File Is Located:

<param name=“ScreenSaverLiveUpdatePath”

value=“http://www.yourwebsiteURL.com/sya_screensaver/”>

Note: This is the path where the LiveUpdate control file can be found. The value for this parameter is typically the same value that you gave “ScreenSaverPath”. Please make sure you *never* rename this folder on your server as your user's screen savers will be looking for the LiveUpdate control file in this directory. If this path cannot be found the LiveUpdate cannot occur.

Specify the Name of the LiveUpdate Control File:

<param name=“ScreenSaverLiveUpdateFile” value=“liveupdate.txt”>

Note: This is the plain-text LiveUpdate control file that contains information about where your latest screen saver files can be downloaded from. You can use whatever filename you like. However, once you decide on a filename, please make sure you *never* change the name as your user's screen savers will be looking for this particular filename. If this file cannot be found the LiveUpdate cannot occur.

Specify ScreenSaverUninstallOption Either True or False:

<param name=“ScreenSaverUninstallOption” value=“true”>

Note: Setting this option to “true” will place an uninstall icon on the user's Windows Desktop that links to the uninstall page. We recommend you set this option to “true” so the user has a way to uninstall your screen saver if the user chooses to do so.

Specify the Name Associated With the Uninstall Icon:

<param name=“ScreenSaverUninstallName” value=“Uninstall Screen Saver”>

Note: This is the text caption that will appear underneath your uninstall icon.

Specify the Name of the Uninstall File:

<param name=“ScreenSaverUninstallFile” value=“uninstall.htm”>

Note: This is the page that uninstalls See You Again Screen Saver™ from the user's computer if the user chooses to uninstall. The uninstall.htm file should be located in the “sya_screensaver” folder (you will create this folder in Step 3).

Specify the Filename of the Uninstall Icon:

<param name=“ScreenSaverUninstall/Icon” value=“ssuninstall.ico”>

Note: This is the uninstall icon that is placed on the user's Windows Desktop that links to the See You Again Screen Saver™ uninstall page. The uninstall icon should be located in the “sya_screensaver” folder (you will create this folder in Step 3).

Once you are finished editing the above parameters you can save your iecab.htm file.

>>A note about the uninstall.htm file: The uninstall.htm file is the page that automatically uninstalls See You Again Screen Saver™ from the user's computer if the user chooses to uninstall. It contains the following two parameters:

Specify ScreenSaverUninstallNow Either True or False:

<param name=“ScreenSaverUninstallNow” value=“true”>

Note: In the uninstall.htm file this parameter should always be set to “true”. Never include this parameter in the iecab.htm file.

Specify the Status Message The User Sees When the Uninstallation Is Complete

<param name=“DoneStatus” value=“Done! See You Again Screen Saver™ has been uninstalled. You may need to reboot your computer for the changes to take effect.”>

The above parameters for uninstall.htm are already preconfigured so you do not need to edit this file.

Step 2-Edit the LiveUpdate File: (Only Complete This Step if You Want to Use LiveUpdate)

LiveUpdate allows you to broadcast up-to-date information to your users simply by updating your screen saver! When you do this everyone who has your screen saver installed will automatically receive the update.

Open “liveupdate.txt” and edit the three parameter lines. In this file you specify the version number of your screen saver and where your latest screen saver files can be downloaded from.

Line 1: Version Number 1

Note: Every time you update your screen saver you must change the version number. Changing the version number signals the screen savers to download your latest version. You can use any numbering scheme though we suggest you start at “1” and increment each version by 1.

Important: When you release a new version please be sure to update the value of the “ScreenSaverLiveUpdateVersion” parameter in your “iecab.htm” file.

Line 2: Specify the Path Where Your Latest Screen Saver Files Are Located:

http://www.yourwebsiteURL.com/sya_screensaver/

Note: This can be the same value of the “ScreenSaverPath” parameter in your “iecab.htm” file if you plan on keeping your latest screen saver files in that directory.

Line 3: Specify Each File of Your Latest Screen Saver: (separate each with a comma, no spaces)

file1.scr,file2.dat

Note: This file list may be different from the original value specified in the “ScreenSaverFiles” parameter in your “iecab.htm” file since the latest version of your screen saver might contain new files. However, the filenames of the two main screen saver files (typically the .scr and .dat files) should remain the same as the filenames you specified in the “ScreenSaverFiles” parameters. This is because if you change the names of those files a “new” screen saver will be downloaded as opposed to “updating” the existing screen saver that is already installed.

Step 3-Upload Files

Upload all the files listed above to your web server. We recommend that you place these files under one directory in a folder named “sya_screensaver”. If you decide to create your own directory structure (including subfolders) you will need to edit the HTML files and change the paths to the files.

Step 4-Activate See You Again Screen Saver™

See You Again Screen Saver™ can be activated two ways. We recommend using both methods:

1. Place a button or text link on your page that your user can click on

2. Begin an “Automatic Initialization” of See You Again Screen Saver™ the first time a visitor comes to your web site

1. Button or Text Link

You can use one of the following three links to get your visitors to activate See You Again Screen Saver™. Simply copy and paste the HTML link code into every web page you want to link to See You Again Screen Saver™. To maximize your screen saver conversions we recommend placing these links on every page.

Note: You may create and use your own button or text link.

Button:

Please right click on the above image and save it as syas_horizontal.gif to your hard drive. Here is the code you can copy and paste into your web page to link the horizontal button to See You Again Screen Saver™. Please make sure you scroll your cursor all the way to the bottom of the textbox to ensure you are copying all the code. Remember to replace “www.yoursite.com” with your real domain name.

<a

href=“javascript:void(window.open(‘http://www.yoursite.com/sya_screensaver/default.htm’,‘ScreenSaver’,‘alwaysRaised=yes, resizable=yes,scrollbars=yes,width=350,height=350,left=100,top=100,screenX=100,screenY=100’));”><img

src=“http://www.yoursite.com/sya_screensaver/sya_screensaver_dl.gif” alt=“Download Our Screen Saver!” border=“0”></a>

Text Link

Here is the code you can copy and paste into your web page to link text to See You Again Screen Saver™. Please make sure you scroll your cursor all the way to the bottom of the textbox to ensure you are copying all the code. Remember to replace “www.yoursite.com” with your real domain name.

Download our screen saver! Click <a

href=“javascript:void(window.open(‘http://www.yoursite.com/sya_screensaver/default.htm’,‘ScreenSaver’,‘alwaysRaised=yes,resizable=yes,scrollbars=yes,width=350,height=350,left=100,top=100,screenX=100,screenY=100’));”>here</a> to install our screen saver right from this web page!

2. Automatic Initialization (Maximize Your Screen Saver Conversions)

We recommend using Automatic Initalization to maximize your screen saver conversions. Here's how it works. The first time a visitor comes to your homepage our popup box appears prompting them to download your screen saver. At this point you have a 50/50 chance of getting the screen saver conversion. So, for example, if your site gets 500 unique visitors a day you will land about 250 screen saver installations a day. Using this technique you will quickly and easily install thousands and thousands of screen savers. Your user is only automatically prompted a single time so this technique is not obtrusive.

You need to add the following javascript code to every web page you want automatic initialization to occur. We recommend placing this javascript code between the opening and closing HEAD tags (e.g. <HEAD> </HEAD>) which are located near the top of your HTML page. Please make sure you scroll your cursor all the way to the bottom of the textbox to ensure you are copying all the code. Remember to replace “www.yoursite.com” with your real domain name.

<script language=“javascript”>
<!--
//If the cookie does not exist this is a first time visit
if (document.cookie.indexOf(“popup=true”) == −1) {

expireDate = new Date
expireDate.setMonth(expireDate.getMonth( )+24)
document.cookie = “popup=true; expires=” + expireDate.toGMTString( )
//popup the window
window open(‘http://www.yoursite.com/sya_screensaver/default.htm’,‘ScreenSaver’,
‘alwaysRaised=yes,resizable=yes,scrollbars=yes,width=350,height=350,left=100,top=100,screenX=
100,screenY=100’)
}
// -->
</script>
--------------------------------------------------------------

Step 5-Display Method

If you want See You Again Screen Saver™ to appear in the default popup box then skip this step. To make See You Again Screen Saver™ show up in the main window, and not in a popup window, change the following javascript portion in your link code. Please make sure you scroll your cursor all the way to the bottom of the textbox to ensure you are copying all the code. Remember to replace “www.yoursite.com” with your real domain name.

From

javascript:void(window.open(‘http://www.yoursite.com/sya_screensaver/default.htm’,‘ScreenSaver’,‘alwaysRaised=yes,resizable=yes,scrollbars=yes,width=350,height=350,left=100,top=100,screenX=100,screenY=100’));

to

javascript:void(window.location.href=(‘http://www.yoursite.com/sya_screensaver/default.htm’));

Step 6-Troubleshooting

See You Again Shortcut™ ships with a convenient diagnostic tool that will help you identify the cause of any problems you may experience.

Internet Explorer

To open the diagnostic tool in Internet Explorer go to Tools/Internet Options/ and click on the Advanced tab. Then scroll about half way down to the Java category and make sure the following option is checked:

Java console enabled (requires restart)

Then shut your browser down and open it again.

Next run through the shortcut creation process on your web site.

After you get the “Done!” message go to View/Java console in your browser. This will open the diagnostic output window and allow you to see exactly what is happening inside the application.

In most cases you will be able to spot what is wrong simply by reading the output. However, if you cannot determine what is wrong please copy and paste the diagnostic output into an e-mail and send it to support@seeyouagainscreensaver.com.

The screen saver software and update technology and installation process is similar to the desktop HTML page software, update technology and installation process with the exception that for the screen saver the file names are different (and, of course, a screen saver is being downloaded and installed as opposed to an HTML page).

In another embodiment of the present invention a coupon code can be embedded in the query string of a linked element in the desktop HTML page or screen saver so that the coupon code can be retrieved by the web site server processor. The coupon code being passed in the querystring can be embedded in the desktop HTML page or screen saver that resides on the visitor processor 16. For example, with linked text in the desktop HTML page this can be done as follows:

<a href=http://www.yoursite.com/default.asp?couponcode=1234>Click here for a coupon!</a>

For the coupon code example, the software code for the vendor's web site on the web site server processor 222 should be customized so the vendor web site server processor 222 can capture the coupon code that is being passed and handle it accordingly.

There may be considerable overlap on how information is “embedded” in the desktop HTML page or screen saver. It may be done by appending variables to the URL (query string).

Desktop Coupons can simply be linked elements contained in a regular desktop portal. The flow as to how one might create a Desktop Coupon for display on the visitor display 212, could be very similar to putting the desktop portal on the display 212 in the sense that the button is simply changed to read “Download Desktop HTML page Coupons!” instead of “Download Desktop HTML Paper”.

However, a smarter implementation of the Coupon Edition might be to work See You Again HTML Paper™ directly into the vendor's ordering process. So, when a visitor fills out a vendor's order form on the vendor's web site the vendor web site automatically prompts the visitor to place a desktop portal containing coupons on the visitor display 212 valid towards a future order (much like supermarkets include coupons in your grocery bag along with your receipt).

In another embodiment of the present invention, a member's (or visitor registered as a member) username and password may be embedded into the desktop HTML page or screen saver. This would eliminate the need for the member to remember their username and password and to repeatedly enter this information. The user can simply click the linked element containing the user's login information and the member is automatically authenticated. The username and password can be embedded in the query string so it can be retrieved by the web site.

Here is an example:

<a href=http://www.yoursite.com/login.asp?username=john&password=secret>Click here to automatically login!</a>

A username of “john” and a password of “secret” have been included in the URL above for the linked element. This embodiment requires customization on the vendor's web site so the vendor can capture the username and password that is being passed and do the automatic authentication.

The flow as to how one might create an Automated Login could be very similar to the basic embodiment in the sense that the button or text link on the vendor web site is simply changed to read “Get an Automated Login!” instead of “Download Desktop HTML page!”

However, a smarter implementation of the Automated Login Edition may be to work See You Again HTML Paper™ directly into the member sign up process. So, when a customer fills out the membership form the vendor web site automatically prompts them to place a desktop portal that contains an Automated Login link on the visitor's display 212.

There also may be linked elements in the desktop HTML page computer software or in the screen saver computer software that contain an affiliate's identification information and link directly to a merchant's web site. So, for example, if I am an affiliate with Amazon.com (trademarked) I can incorporate a link to Amazon.com (trademarked) that contains my affiliate link (that way, if people buy from Amazon (trademarked) using my desktop portal, I get credit for the sale).

In addition to using desktop HTML page to link to a web site, it can also be used to link to executable programs that the vendor wants to distribute. Here is an example that will help clarify. If I am a software publisher I can have a desktop portal that links to my web site but also has links to demo versions of my latest software. The key difference is the links to the demo software are to the user's or visitor's local hard drive, such as visitor processor 216, (not a web site). This is possible because the desktop HTML page computer software, in addition to downloading an HTML page, can also download executable programs (e.g. .exe files) and other types of computer software files. Since that is the case the desktop portal can launch software on the user's local hard drive, such as visitor processor 216, so they can use it.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. A method comprising the steps of:
causing a desktop HTML page to be placed on a visitor display and desktop HTML page computer software to be placed on a visitor processor in response to an install desktop HTML page process started by the selection of a first link on a vendor's web site page by a visitor to the vendor's web site page;
wherein the desktop HTML page is placed on the visitor display and the desktop HTML page computer software is placed on the visitor processor, so that the desktop HTML page is displayed when the visitor processor is booted up and when no other application computer software programs are active on the visitor display.

2. The method of claim 1 wherein
the desktop HTML page placed on the visitor display includes information from the vendor.

3. The method of claim 2 wherein
the information from the vendor includes advertising material for the vendor.

4. The method of claim 1 wherein
the desktop HTML page placed on the visitor display, causes the vendor's web site to be accessed when the visitor clicks on a linked element in the desktop HTML page.

5. The method of claim 1 wherein
the desktop HTML page includes a broadcast window, which provides updated information from the internet.

6. The method of claim 1 wherein
the desktop HTML page is updateable by a vendor through one or more desktop HTML page files which run an update process and which are stored on the visitor processor.

7. A method comprising the steps of:
causing a screen saver to be placed on a visitor display and screen saver computer software to be placed on a visitor processor in response to an install screen saver process started by the selection of a first link on a vendor's web site page by a visitor to the vendors web site page;
wherein the screen saver is placed on the visitor display and the screen saver computer software is placed on the visitor processor, so that the screen saver is displayed when the visitor processor is booted up and when a visitor interactive device has not been used for some period of time.

8. The method of claim 7 wherein
the screen saver placed on the visitor display includes information from the vendor.

9. The method of claim 8 wherein
the information from the vendor included advertising material for the vendor.

10. The method of claim 6 wherein
the screen saver is updateable by a vendor through one or more screen saver files, which run an update process and which are stored on the visitors processor.
